(19) United States
(12) Patent Application Publication
(10) Pub. No.: US 2009/0323637 A1
(43) Pub. Date: Dec. 31, 2009

(54) Radio Communication Method, Base Station Controller and Radio Communication Terminal

(75) Inventors: Susumu Kashiwase, Yokohama (JP); Kugo Morita, Yokohama (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/375,395

(22) PCT Filed: Jul. 27, 2007
(86) PCT No.: PCT/JP2007/064810

§ 371 Date: Sep. 9, 2009

(30) Foreign Application Priority Data
Jul. 28, 2006 (JP) 2006-207239
Jul. 28, 2006 (JP) 2006-207253

(51) Int. Cl. H04W 36/00

(52) U.S. Cl. 370/331

(57) ABSTRACT

The present invention is summarized as a radio communication method including the steps of: calculating a transmission power difference between a transmission power value of a first carrier and a transmission power value of a second carrier; determining whether or not the transmission power difference exceeds a threshold set on the basis of a maximum transmission power difference allowable between the first carrier and the second carrier; and when the transmission power difference exceeds the threshold set on the basis of the maximum transmission power difference, transmitting a handoff instruction for one of the first carrier and the second carrier that has a higher transmission power value.

### TECHNICAL FIELD

The present invention relates to a radio communication method in reverse link by multicarrier using multiple carriers, to a base station controller for controlling reverse link communications using multicarrier from a radio communication terminal to a radio base station, and to a radio communication terminal for performing communications by multicarrier.

### BACKGROUND ART

In recent years, as applications, such as moving images or games, to be handled have been diversified and sophisticated, the data transmission rate in a mobile communication system has been strongly demanded to be speeded up. With such a background, the Third Generation Partnership Project 2 (3GPP2), for example, defines a scheme for implementing high speed data transmissions by using multiple carriers bundled in a upper layer (so-called multicarrier).

In the case of multicarrier, a radio communication terminal (Access Terminal) generally employs a configuration in which multiple carriers are transmitted by use of a single radio communication network, in view of downsizing, reduction in manufacturing cost or the like. Thus, in order to reduce interference between adjacent carriers that are adjacent to each other with a predetermined frequency interval (1.25 MHz interval), it is provided that a transmission power difference between adjacent carriers should be within a predetermined threshold (MaxRLTxPwrDiff, 15 dB, for example) (Non-patent document 1, for example).

Non-patent document 1: “cdma2000 High Rate Packet Data Air Interface 3GPP2 C.S0024-B Version 1.0”, 3GPP2, June 2006

### DISCLOSURE OF THE INVENTION

As described above, 3GPP2 provides that a transmission power difference between adjacent carriers be controlled to be within a predetermined threshold (MaxRLTxPwrDiff). In some cases, however, the transmission power difference cannot be maintained within the predetermined threshold under some communication conditions between a radio communication terminal and a radio base station (Access Network).

For example, when a radio communication terminal moves away from a first radio base station that is currently performing communications by use of a first carrier and simultaneously moves toward a second radio base station that is currently performing communications by use of a second carrier adjacent to the first carrier with a predetermined frequency interval, the radio communication terminal needs to increase the transmission power of the first carrier to maintain communications with the first radio base station using the first carrier. In addition, as the radio communication terminal comes closer to the second radio base station, the radio communication terminal reduces the transmission power of the second carrier.

In this way, in some cases, the radio communication terminal may not be able to maintain the transmission power difference within the predetermined threshold to continue communications currently being performed with the first radio base station and the second radio base station.

Hence, the present invention was made in light of such the circumstances, and it is an object of the present invention to provide a radio communication method, a base station controller and a radio communication terminal that are capable of maintaining communications by multicarrier, while preventing interference between adjacent carriers which are adjacent to each other with a predetermined frequency interval.

One aspect of the present invention is summarized as a radio communication method in reverse link from a radio communication terminal to a radio base station by multicarrier using at least a first carrier and a second carrier that is adjacent to the first carrier with a predetermined frequency interval, the method including the steps of: acquiring a transmission power value of the first carrier and a transmission power value of the second carrier from the radio base station; calculating a transmission power difference between the first carrier and the second carrier; determining whether or not the transmission power difference exceeds a threshold set on the basis of a maximum transmission power difference allowable between the first carrier and the second carrier; and when the transmission power difference exceeds the threshold set on the basis of the maximum transmission power difference, transmitting a handoff instruction for one of the first carrier and the second carrier that has a higher transmission power value to the radio base station connected to the radio communication terminal via the one of the carriers that has the higher transmission power value.

According to the aspect, if the transmission power difference exceeds the threshold set on the basis of the maximum transmission power difference, the transmission power difference can be maintained within the maximum transmission power difference by transmitting a handoff instruction for one of the carriers that has a higher transmission power value to the radio base station connected to the radio communication terminal via the one of the carriers that has the higher transmission power value. Thus, communications by multicarrier can be maintained while interference between adjacent carriers that are adjacent to each other with a predetermined frequency interval is controlled.

One aspect of the present invention is summarized in that, in the aspects of the present invention as described above, the transmission power difference is calculated in a predetermined cycle in the step of calculating the transmission power difference, the radio communication method further including the step of determining whether or not the transmission power difference is increasing, on the basis of the transmission power difference calculated in the predetermined cycle, in which when it is determined that the transmission power difference is increasing, a handoff instruction for the one of the first carrier and the second carrier that has the higher transmission power is transmitted to the radio base station connected to the radio communication terminal via the one of the carriers that has the higher transmission power in the step of transmitting the handoff instruction.

One aspect of the present invention is summarized as a radio communication method in reverse link from a radio communication terminal to a radio base station by multicarrier using at least a first carrier and a second carrier that is adjacent to the first carrier with a predetermined frequency interval, the method including the steps of: acquiring a transmission power value of the first carrier and a transmission power value of the second carrier from the radio base station; calculating a transmission power difference between the first carrier and the second carrier; determining whether or not the transmission power difference exceeds a threshold set on the basis of a maximum transmission power difference allowable between the first carrier and the second carrier; and when the transmission power difference exceeds the threshold set on the basis of the maximum transmission power difference, transmitting a handoff instruction for one of the first carrier and the second carrier that has a lower transmission power value to the radio base station connected to the radio communication terminal via the one of the carriers that has the lower transmission power value.

According to the aspect, if the transmission power difference exceeds the threshold set on the basis of the maximum transmission power difference, the transmission power difference can be maintained within the maximum transmission power difference by transmitting a handoff instruction for one of the carriers that has a lower transmission power value to the radio base station connected to the radio communication terminal via the one of the carriers that has the lower transmission power value. Thus, communications by multicarrier can be maintained while interference between adjacent carriers that are adjacent to each other with a predetermined frequency interval is controlled.

One aspect of the present invention is summarized in that, in the aspects of the present invention as described above, the transmission power difference is calculated in a predetermined cycle in the step of calculating the transmission power difference, the method further including the step of determining whether or not the transmission power difference is increasing, on the basis of the transmission power difference calculated in the predetermined cycle, in which when it is determined that the transmission power difference is increasing, a handoff instruction for the one of the first carrier and the second carrier that has the lower transmission power value is transmitted to the radio base station connected to the radio communication terminal via the one of the carriers that has the lower transmission power value in the step of transmitting the handoff instruction.

One aspect of the present invention is summarized as a base station controller for controlling communications in reverse link from a radio communication terminal to a radio base station by multicarrier using at least a first carrier and a second carrier that is adjacent to the first carrier with a predetermined frequency interval, the controller including: a transmission power value acquisition unit configured to acquire a transmission power value of the first carrier and a transmission power value of the second carrier from the radio base station (transmission power information receiver 210); a transmission power difference calculator configured to calculate a transmission power difference between the first carrier and the second carrier on the basis of the transmission power value of the first carrier and the transmission power value of the second carrier, which are acquired by the transmission power value acquisition unit (transmission power difference calculator 220); a transmission power difference determination unit configured to determine whether or not the transmission power difference calculated by the transmission power difference calculator exceeds a threshold set on the basis of a maximum transmission power difference allowable between the first carrier and the second carrier (transmission power difference calculator 220); and a handoff instruction transmitter configured to transmit a handoff instruction for one of the first carrier and the second carrier that has a higher transmission power value to the radio base station connected to the radio communication terminal via the one of the carriers that has the higher transmission power value, when it is determined by the transmission power difference determination unit that the transmission power difference exceeds the threshold set on the basis of the maximum transmission power difference (handoff instruction transmitter 230).

One aspect of the present invention is summarized in that, in the aspects of the present invention as described above, the transmission power difference calculator calculates the transmission power difference in a predetermined cycle, the base station controller further including a power difference determination unit configured to determine whether or not the transmission power difference is increasing, on the basis of the transmission power difference calculated in the predetermined cycle by the transmission power difference calculator (transmission power difference determination unit 240), in which when it is determined that the transmission power difference is increasing, the handoff instruction transmitter transmits a handoff instruction for the one of the first carrier and the second carrier that has the higher transmission power value to the radio base station connected to the radio communication terminal via the one of the carriers that has the higher transmission power value.

One aspect of the present invention is summarized as a base station controller for controlling communications in reverse link from a radio communication terminal to a radio base station by multicarrier using at least a first carrier and a second carrier that is adjacent to the first carrier with a predetermined frequency interval, the controller including: a transmission power value acquisition unit configured to acquire a transmission power value of the first carrier and a transmission power value of the second carrier from the radio base station (transmission power information receiver 210); a transmission power difference calculator configured to calculate a transmission power difference between the first carrier and the second carrier on the basis of the transmission power value of the first carrier and the transmission power value of the second carrier, which are acquired by the transmission power value acquisition unit (transmission power difference calculator 220); a transmission power difference determination unit configured to determine whether or not the transmission power difference calculated by the transmission power difference calculator exceeds a threshold set on the basis of a maximum transmission power difference allowable between the first carrier and the second carrier (transmission power difference calculator 220); and a handoff instruction transmitter configured to transmit a handoff instruction for one of the first carrier and the second carrier that has a lower transmission power value to the radio base station connected to the radio communication terminal via the one of the carriers that has the lower transmission power value, when it is determined by the transmission power difference determination unit that the transmission power difference exceeds the threshold set on the basis of the maximum transmission power difference (handoff instruction transmitter 230).

One aspect of the present invention is summarized in that, in the aspects of the present invention as described above, the transmission power difference calculator calculates the transmission power difference in a predetermined cycle, the base station controller further including a power difference determination unit configured to determine whether or not the transmission power difference is increasing, on the basis of the transmission power difference calculated in the predetermined cycle by the transmission power difference calculator (transmission power difference determination unit 240), in which when it is determined that the transmission power difference is increasing, the handoff instruction transmitter transmits a handoff instruction for the one of the first carrier and the second carrier that has the lower transmission power value to the radio base station connected to the radio communication terminal via the one of the carriers that has the lower transmission power value.

One aspect of the present invention is summarized as a radio communication method in reverse link by multicarrier using at least a first carrier and a second carrier that is adjacent to the first carrier with a predetermined frequency interval, the method including the steps of: calculating a transmission power difference between the first carrier and the second carrier; determining whether or not the transmission power difference exceeds a threshold set on the basis of a maximum transmission power difference allowable between the first carrier and the second carrier; and when the transmission power difference exceeds the threshold set on the basis of the maximum transmission power difference, transmitting a handoff request for one of the first carrier and the second carrier that has higher transmission power to the radio base station connected to the radio communication terminal via the one of the carriers that has the higher transmission power.

According to the aspect, if the transmission power difference exceeds the threshold set on the basis of the maximum transmission power difference, a handoff request for one of the first carrier and the second carrier that has higher transmission power is transmitted to the radio base station connected to the radio communication terminal via the one of the carriers that has the higher transmission power. Thus, communications by multicarrier can be maintained while interference between adjacent carriers that are adjacent to each other with a predetermined frequency interval is controlled.

One aspect of the present invention is summarized in that, in the aspects of the present invention as described above, the transmission power difference is calculated in a predetermined cycle in the step of calculating the transmission power difference, the radio communication method further including the step of determining whether or not the transmission power difference is increasing, on the basis of the transmission power difference calculated in the predetermined cycle, in which when it is determined that the transmission power difference is increasing, a handoff request for the one of the first carrier and the second carrier that has the higher transmission power is transmitted to the radio base station connected to the radio communication terminal via the one of the carriers that has the higher transmission power, in the step of transmitting the handoff request.

One aspect of the present invention is summarized as a radio communication method in reverse link by multicarrier using at least a first carrier and a second carrier that is adjacent to the first carrier with a predetermined frequency interval, the method including the steps of: calculating a transmission power difference between the first carrier and the second carrier; determining whether or not the transmission power difference exceeds a threshold set on the basis of a maximum transmission power difference allowable between the first carrier and the second carrier; and when the transmission power difference exceeds the threshold set on the basis of the maximum transmission power difference, transmitting a handoff request for one of the first carrier and the second carrier that has lower transmission power to the radio base station connected to the radio communication terminal via the one of the carriers that has the lower transmission power.

According to the aspect, if the transmission power difference exceeds the threshold set on the basis of the maximum transmission power difference, a handoff request for one of the first carrier and the second carrier that has lower transmission power is transmitted to the radio base station connected to the radio communication terminal via the one of the carriers that has the lower transmission power. Thus, communications by multicarrier can be maintained while interference between adjacent carriers that are adjacent to each other with a predetermined frequency interval is controlled.

One aspect of the present invention is summarized in that, in the aspects of the present invention as described above, the transmission power difference is calculated in a predetermined cycle in the step of calculating the transmission power difference, the radio communication method further including the step of determining whether or not the transmission power difference is increasing, on the basis of the transmission power difference calculated in the predetermined cycle, in which when it is determined that the transmission power difference is increasing, a handoff request for the one of the first carrier and the second carrier that has the lower transmission power is transmitted to the radio base station connected to the radio communication terminal via the one of the carriers that has the lower transmission power, in the step of transmitting the handoff request.

One aspect of the present invention is summarized as a radio communication terminal for performing communications by multicarrier using at least a first carrier and a second carrier that is adjacent to the first carrier with a predetermined frequency interval, the communication terminal including: a transmission power difference calculator configured to calculate a transmission power difference between the first carrier and the second carrier (transmission power difference calculator 22); a transmission power difference determination unit configured to determine whether or not the transmission power difference calculated by the transmission power difference calculator exceeds a threshold set on the basis of a maximum transmission power difference allowable between the first carrier and the second carrier (transmission power difference calculator 22); and a handoff request transmitter configured to transmit a handoff request for one of the first carrier and the second carrier that has higher transmission power to the radio base station connected to the radio communication terminal via the one of the carriers that has the higher transmission power, when it is determined by the transmission power difference determination unit that the transmission power difference exceeds the threshold set on the basis of the maximum transmission power difference (communication controller 23).

One aspect of the present invention is summarized in that, in the aspects of the present invention as described above, the transmission power difference calculator calculates the transmission power difference in a predetermined cycle, the radio communication terminal further including a power difference determination unit configured to determine whether or not the transmission power difference is increasing, on the basis of the transmission power difference calculated in the predetermined cycle by the transmission power difference calculator (transmission power difference determination unit 25), in which when it is determined that the transmission power difference is increasing, the handoff request transmitter transmits a handoff request for the one of the first carrier and the second carrier that has the higher transmission power to the radio base station connected to the radio communication terminal via the one of the carriers that has the higher transmission power.

One aspect of the present invention is summarized as a radio communication terminal for performing communications by multicarrier using at least a first carrier and a second carrier that is adjacent to the first carrier with a predetermined frequency interval, the communication terminal including: a transmission power difference calculator configured to calculate a transmission power difference between the first carrier and the second carrier (transmission power difference calculator 22); a transmission power difference determination unit configured to determine whether or not the transmission power difference calculated by the transmission power difference calculator exceeds a threshold set on the basis of a maximum transmission power difference allowable between the first carrier and the second carrier (transmission power difference calculator 22); and a handoff request transmitter configured to transmit a handoff request for one of the first carrier and the second carrier that has lower transmission power to the radio base station connected to the radio communication terminal via the one of the carriers that has the lower transmission power, when it is determined by the transmission power difference determination unit that the transmission power difference exceeds the threshold set on the basis of the maximum transmission power difference (communication controller 23).

One aspect of the present invention is summarized in that, in the aspects of the present invention as described above, the transmission power difference calculator calculates the transmission power difference in a predetermined cycle, the radio communication terminal further including a power difference determination unit configured to determine whether or not the transmission power difference is increasing, on the basis of the transmission power difference calculated in the predetermined cycle by the transmission power difference calculator, in which when it is determined that the transmission power difference is increasing, the handoff request transmitter transmits a handoff request for the one of the first carrier and the second carrier that has the lower transmission power to the radio base station connected to the radio communication terminal via the one of the carriers that has the lower transmission power.

According to the aspects of the present invention, it is possible to provide a radio communication method and a base station controller capable of maintaining communications by multicarrier while controlling interference between adjacent carriers that are adjacent to each other with a predetermined frequency interval.

### BRIEF DESCRIPTION OF THE DRAWINGS

FIG. 1 is a diagram showing an overall schematic configuration of a communication system 300 according to a first embodiment and a third embodiment of the present embodiment.

FIG. 2 is a diagram showing frequency bandwidth in reverse link according to the first embodiment and the third embodiment of the present invention.

FIG. 3 is a block configuration diagram of a radio communication terminal 10 according to the first embodiment and the third embodiment of the present invention.

FIG. 4 is a functional block configuration diagram of a base station controller 200 according to the first embodiment of the present invention.

FIG. 5 is a flowchart showing operation of the radio communication terminal 10 according to the first embodiment of the present invention.

FIG. 6 is a flowchart showing operation of the base station controller 200 according to the first embodiment of the present invention (Pattern 1).

FIG. 7 is a flowchart showing the operation of the base station controller 200 according to the first embodiment of the present invention (Pattern 2).

FIG. 8 is a functional block configuration diagram of a base station controller 200 according to a second embodiment of the present invention.

FIG. 9 is a view for illustrating calculation of an estimated curve difference (a difference in values calculated by an estimated curve expression of each carrier) according to the second embodiment and the fourth embodiment of the present invention.

FIG. 10 is a flowchart showing operation of the base station controller 200 according to the second embodiment of the present invention.

FIG. 11 is a diagram showing an example of a table stored in a memory 19 according to the third embodiment of the present invention.

FIG. 12 is a functional block configuration diagram of a controller 20 according to the third embodiment of the present invention.

FIG. 13 is a flowchart showing operation of a radio communication terminal 10 according to the third embodiment of the present invention (Pattern 1).

FIG. 14 is a flowchart showing the operation of the radio communication terminal 10 according to the third embodiment of the present invention (Pattern 2).

FIG. 15 is a flowchart showing the operation of the radio communication terminal 10 according to the third embodiment of the present invention (Pattern 3).

FIG. 16 is a flowchart showing the operation of the radio communication terminal 10 according to the third embodiment of the present invention (Pattern 4).

FIG. 17 is a functional block configuration diagram of a controller 20 according to the fourth embodiment of the present invention.

FIG. 18 is a flowchart showing operation of a radio communication terminal 10 according to the fourth embodiment of the present invention.

### BEST MODE FOR CARRYING OUT THE INVENTION

Next, embodiments of the present invention will be described. In the following description of the drawings, a same or similar reference numeral is given to a same or similar part. However, it should be noted that the drawings are schematic and the ratio of each dimension differs from actual ratio.

Thus, specific dimensions and the like are to be determined by referring to the following description. In addition, a relationship or a ratio of mutual dimensions may differ among the drawings, as a matter of course.

### First Embodiment

### Overall Schematic Configuration of Communication System

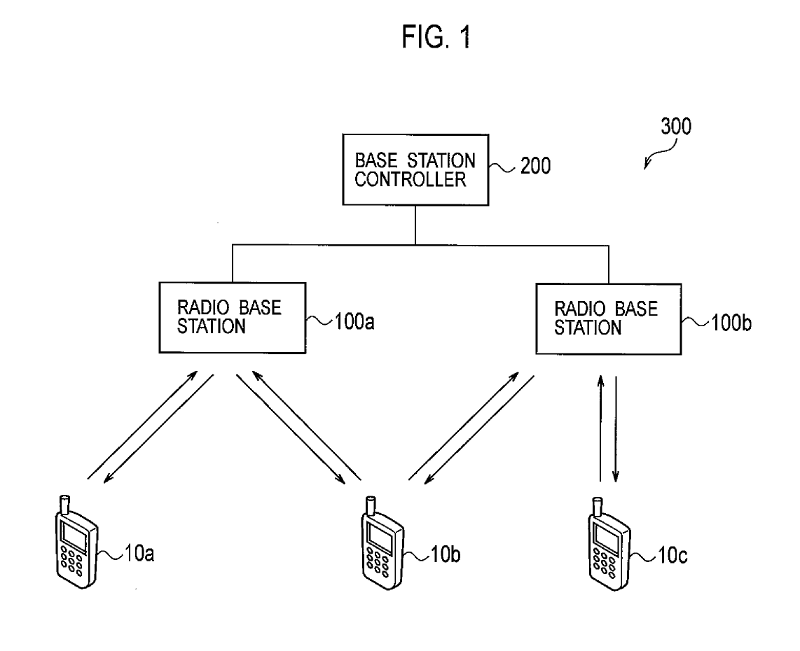

An overall schematic configuration of a communication system according to a first embodiment of the present embodiment will be described hereinafter with reference to the drawings. FIG. 1 shows an overall schematic configuration of a communication system 300 according to the first embodiment of the present embodiment.

As shown in FIG. 1, the communication system 300 includes multiple radio communication terminals 10 (a radio communication terminal 10a to a radio communication terminal 10c), multiple radio base stations 100 (a radio base station 100a and a radio base station 100b), and a base station controller 200.

Each of radio communication terminals 10 transmits reverse link data to each of radio base stations 100 by using a reverse link frequency band assigned for transmitting the reverse link data. Specifically, the reverse link frequency band is divided into multiple carriers. The radio communication terminal 10 transmits the reverse link data to the base radio station 100 by using the multiple carriers bundled in an upper layer (multicarrier).

In addition, the radio communication terminal 10 receives forward link data from a radio base station 100 by using a forward link frequency band assigned for transmitting the forward link data. Specifically, the forward link frequency band is divided into multiple carriers. The radio communication terminal 10 receives the forward link data from the radio base stations 100 by using the multiple carriers bundled in an upper layer (multicarrier).

Note that the radio communication terminal 16, as in the case of the radio communication terminal 10a or the radio communication terminal 10c, may communicate with a single radio base station 100. In addition, the radio communication terminal 10 may communicate with multiple radio base stations 100, as in the case of the radio communication terminal 10b.

The radio base station 100 receives the reverse link data from the radio communication terminal 10 by using the reverse link frequency band assigned for transmitting the reverse link data. The radio base station 100 also transmits the forward link data to the radio communication terminals 10 by using the forward link frequency band assigned for transmitting the forward link data.

The base station controller 200 controls communications made between the radio communication terminals 10 and the radio base stations 100. The base station controller 200 performs operations such as handoff in which the radio communication terminal 10 switches a radio base station 100 for communicating therewith to another.

In the communication system 300, the radio communication terminal 10 performs open loop control for controlling transmission power of reverse link data on the basis of reception power of forward link data received from the radio base station 100. The radio communication terminal 10 also performs closed loop control for controlling transmission power of reverse link data based on power control information received from the radio base station 100. The power control information herein is information that the radio base station 100 generates on the basis of reception quality (for example, signal to interference ratio (SIR)) of the reverse link data received from the radio communication terminal 10.

### (Reverse Link Frequency Band)

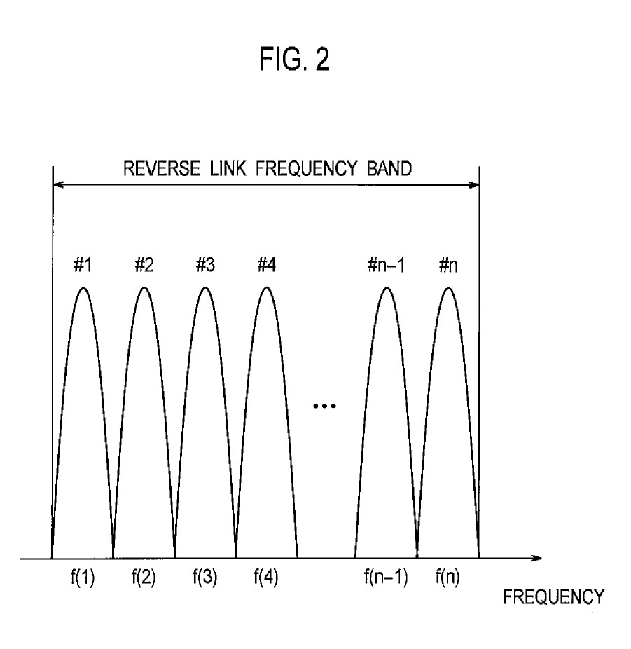

A reverse link frequency band according to the first embodiment of the present invention will be described hereinafter with reference to the drawings. FIG. 2 shows the reverse link frequency band according to the first embodiment of the present invention.

As shown in FIG. 2, the reverse link frequency band is divided into multiple carriers (carrier #1 to carrier #n). In addition, center frequencies of carriers are f (1) to f (n), respectively. The center frequencies of the respective carriers are adjacent to each other being spaced apart at a predetermined frequency interval (e.g., 1.25 MHz). Two carriers having their center frequencies being adjacent to each other will be hereinafter referred to as adjacent carriers.

### (Configuration of Radio Communication Terminals)

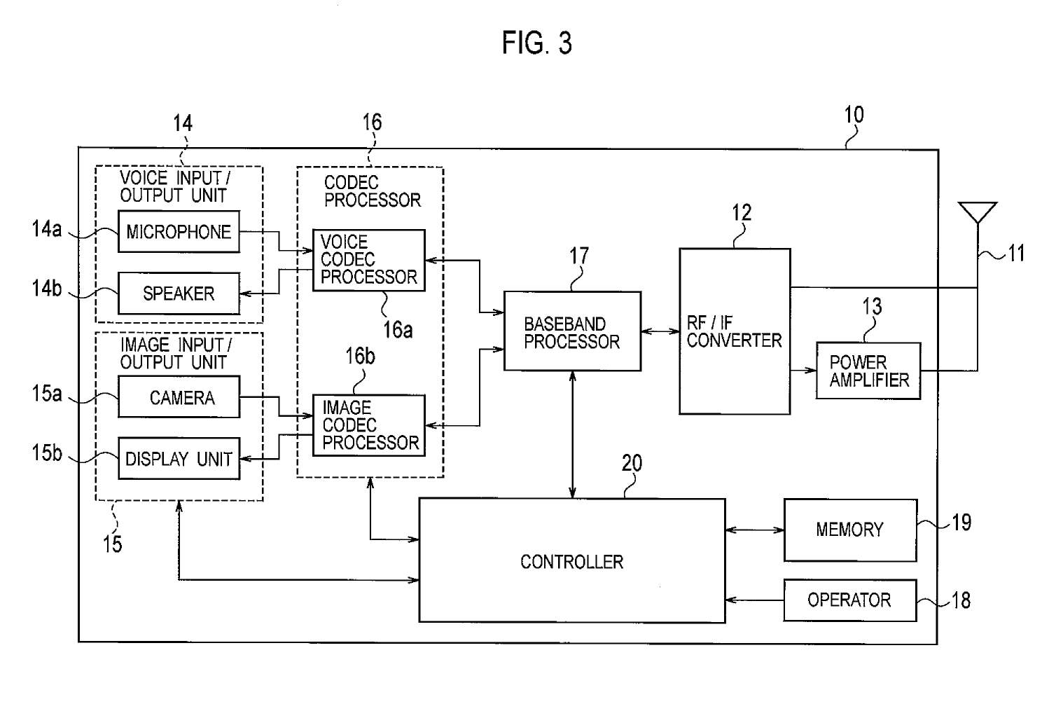

A configuration of the radio communication terminal according to the first embodiment of the present invention will be described hereinafter with reference to the drawings. FIG. 3 is a block configuration diagram showing the radio communication terminal 10 according to the first embodiment of the present invention. Since the radio communication terminals 10a to 10c have similar configurations, they will be collectively referred to as a radio communication terminal 10 in the following description.

As shown in FIG. 3, the radio communication terminal 10 includes an antenna 11, an RF/IF converter 12, a power amplifier 13, a voice input/output unit 14, an image input/output unit 15, a codec processor 16, a baseband processor 17, an operator 18, a memory 19, and a controller 20.

The antenna 11 receives a signal (a reception signal) transmitted by the radio base stations 100. The antenna 11 also transmits a signal (a transmission signal) to the radio base stations 100.

The RF/IF converter 12 converts a frequency (Radio Frequency (RF)) of a reception signal received by the antenna 11 into a frequency (Intermediate Frequency (IF)) to be handled by the baseband processor 17. The RF/IF converter 12 also converts the frequency (IF) of a transmission signal acquired from the baseband processor 17 into the frequency (RF) to be used in radio communications. In addition, the RF/IF converter 12 inputs the transmission signal converted into the radio frequency (RF) to the power amplifier 13.

The power amplifier 13 amplifies the transmission signal acquired from the RF/IF converter 12. The amplified transmission signal is inputted to the antenna 11.

The voice input/output unit 14 has a microphone 14a for collecting voice and a speaker 14b for outputting voice. The microphone 14a inputs a voice signal into the codec processor 16 on the basis of the collected voice. The speaker 14b outputs voice on the basis of the voice signal acquired from the codec processor 16.

The image input/output unit 15 includes a camera 15a for capturing an object, and a display unit 15b for displaying characters or images, etc. The camera 15a inputs an image signal to the codec processor 16 on the basis of captured images (still images and moving images). The display unit 15b displays images on the basis of the image signal acquired from the codec processor 16. The display unit 15b also displays characters to be inputted through the operator 18.

The codec processor 16 includes: a voice codec processor 16a for encoding and decoding a voice signal according to a predetermined encoding scheme (EVRC (Enhanced Variable Rate Codec), AMR (Advanced Multi Rate Codec) or G.729 compliant with ITU-T, for example); and an image codec processor 16b for encoding and decoding an image signal according to a predetermined encoding scheme (MPEG-4 etc, for example).

The voice codec processor 16a encodes a voice signal acquired from the voice input/output unit 14. The voice codec processor 16a also decodes a voice signal acquired from the baseband processor 17. The image codec processor 16b encodes an image signal acquired from the image input/output unit 15. The image codec processor 16b also decodes an image signal acquired from the baseband processor 17.

The baseband processor 17 modulates a transmission signal or demodulates a reception signal according to a predetermined modulation scheme (QPSK or 16QAM), or the like. Specifically, the baseband processor 17 modulates a baseband signal such as a voice signal or an image signal acquired from the codec processor 16. The modulated baseband signal (transmission signal) is inputted into the RF/IF converter 12. The baseband processor 17 also demodulates a reception signal acquired from the RF/IF converter 12. The demodulated reception signal (baseband signal) is inputted into the codec processor 16.

The baseband processor 17 modulates information generated by the controller 20. The modulated information (transmission signal) is inputted into the RF/IF converter 12. The baseband processor 17 also demodulates a reception signal acquired from the RF/IF converter 12. The demodulated reception signal is inputted into the controller 20.

The operator 18 is a group of keys consisting of input keys for allowing characters, digits, or the like to be inputted, a response key for responding to incoming communications (calling), or a calling key for calling (originating a call), etc. In addition, when each key is pressed, the operator 18 allows an input signal corresponding to the pressed key to be inputted to the controller 20.

The memory 19 stores a program for controlling operation of the radio communication terminal 10, various types of data such as history of originated/received calls, an address book, etc. The memory 19 is formed of a flash memory that is a nonvolatile semiconductor memory, or a SRAM (Static Random Access Memory) that is a volatile semiconductor memory, etc.

The controller 20 controls operation of the radio communication terminal 10 (the image input/output unit 15, the codec processor 16, the baseband processor 17, etc.) according to the program stored in the memory 19.

For example, the controller 20 controls transmission power of reverse link data for each carrier. Specifically, the controller 20 controls the transmission power of the reverse link data on the basis of reception quality (SIR, for example) of forward link data received from the radio base station 100 to which the reverse link data is transmitted (open loop control).

The controller 20 also controls transmission power of reverse link data on the basis of power control information received from the radio base stations 100 to which reverse link data is transmitted (closed loop control). As described above, the power control information is information that the radio base station 100 generates on the basis of reception quality (SIR, for example) of the reverse link data. The power control information requests the decrease or the increase of the transmission power for the reverse link data.

Furthermore, the controller 20 generates transmission power information including a transmission power value of reverse link data that is determined by the open loop control or closed loop control. Note that the transmission power information is transmitted to the base station controller 200 via the radio base station 100.

Here, the transmission power information may be information including transmission power values of all of the carriers currently connected to the radio communication terminal 10, and may be transmitted to the base station controller 200 via one of the radio base stations 100. Moreover, the transmission power information may be information including a transmission power value of a carrier by which the radio communication terminal 10 is currently connected to each of the radio base stations 100, and may be transmitted individually to the base station controller 200 via each of the radio base stations 100.

Note that the transmission power information may be information including a transmission power value of one of adjacent carriers.

### (Configuration of Base Station Controller)

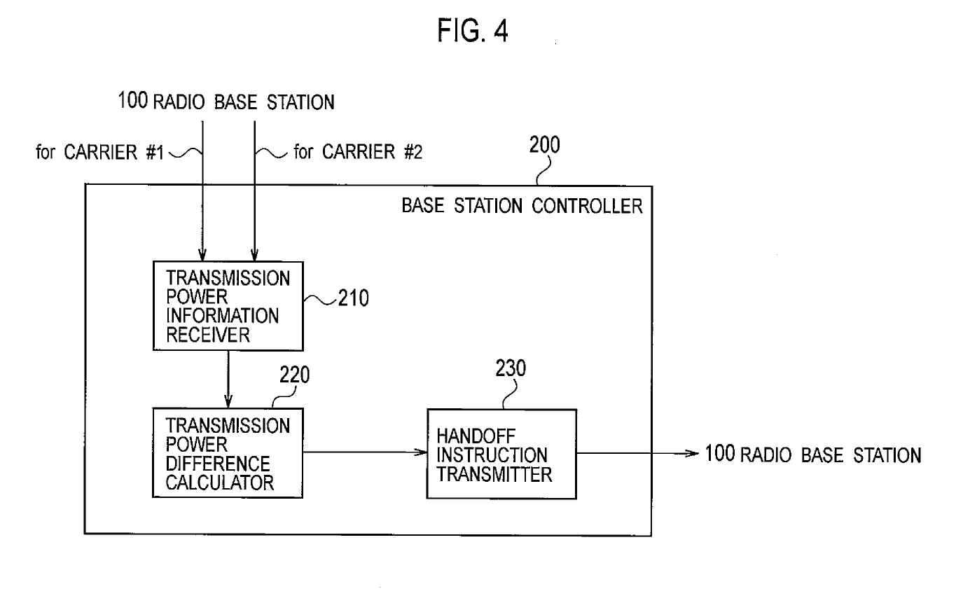

A configuration of a base station controller according to the first embodiment of the present invention will be described hereinafter with reference to the drawings. FIG. 4 is a functional block configuration diagram showing the base station controller 200 according to the first embodiment of the present invention.

As shown in FIG. 4, the base station controller 200 includes a transmission power information receiver 210, a transmission power difference calculator 220 and a handoff instruction transmitter 230.

The transmission power information receiver 210 receives the transmission power information including a transmission power value of one of adjacent carriers (reverse link data) from a radio base station 100.

As an example, cited is a case where a radio communication terminal 10 is connected to a radio base station 100a by use of a carrier #1 while the communication terminal 10 is also being connected to a radio base station 100b by use of a carrier #2. In this example, the transmission power information receiver 210 receives transmission power information including a transmission power value of the carrier #1 from the radio base station 100a, and receives transmission power information including a transmission power value of the carrier #2 from the radio base station 100b.

Note that the transmission power information receiver 210 may collectively receive transmission power information including the transmission power values of the carrier #1 and the carrier #2 from the radio base station 100a. Likewise, the transmission power information receiver 210 may collectively receive the transmission power information including the transmission power values of the carrier #1 and the carrier #2 from the radio base station 100b.

The transmission power difference calculator 220 calculates a difference between transmission powers of adjacent carriers on the basis of the transmission power information received by the transmission power information receiver 210 (hereinafter referred to as a transmission power difference). In addition, the transmission power difference calculator 220 determines whether or not a transmission power difference between adjacent carriers exceeds a threshold set on the basis of a maximum transmission power difference (MaxRLTxPwrDiff) allowable between adjacent carriers. Note that when the transmission power difference between adjacent carriers exceeds the threshold set on the basis of the maximum transmission power difference, the transmission power difference calculator 220 informs the handoff instruction transmitter 230 that the transmission power difference between the adjacent carriers has exceeded the threshold set on the basis of the maximum transmission power difference.

The threshold to be set on the basis of the maximum transmission power difference may be the maximum transmission power difference itself, or may be a value smaller than the maximum transmission power difference (for example, a value obtained by multiplying the maximum transmission power difference by a predetermined ratio (0.9)).

When informed that the transmission power difference between adjacent carriers exceeds the threshold set on the basis of the maximum transmission power difference, the handoff instruction transmitter 230 transmits a handoff instruction for instructing handoff of one of the adjacent carriers that has higher transmission power to the radio base station 100 connected to the radio communication terminal 10 via the carrier with higher transmission power.

Meanwhile, when notified that the transmission power difference between adjacent carriers exceeds the threshold set on the basis of the maximum transmission power difference, the handoff instruction transmitter 230 may transmit a handoff instruction for instructing handoff of one of the adjacent carriers that has lower transmission power to the radio base station 100 connected to the radio communication terminal 10 via the carrier with lower transmission power.

In addition, the handoff instruction transmitter 230 may select a radio base station 100 to be the handoff destination and a carrier to be the handoff destination, and then transmit a handoff instruction to the radio base station 100 to be the handoff destination, the handoff instruction including the information on the carrier to be the handoff destination.

In this case, the handoff instruction transmitter 230 preferably acquires reception quality (Block Error Rate (BLER), for example) of forward link data that is measured by the radio communication terminal 10 from the radio communication terminal 10, and then selects a radio base station 100 to be the handoff destination on the basis of the acquired reception quality of the forward link data.

### (Operation of Radio Communication Terminal)

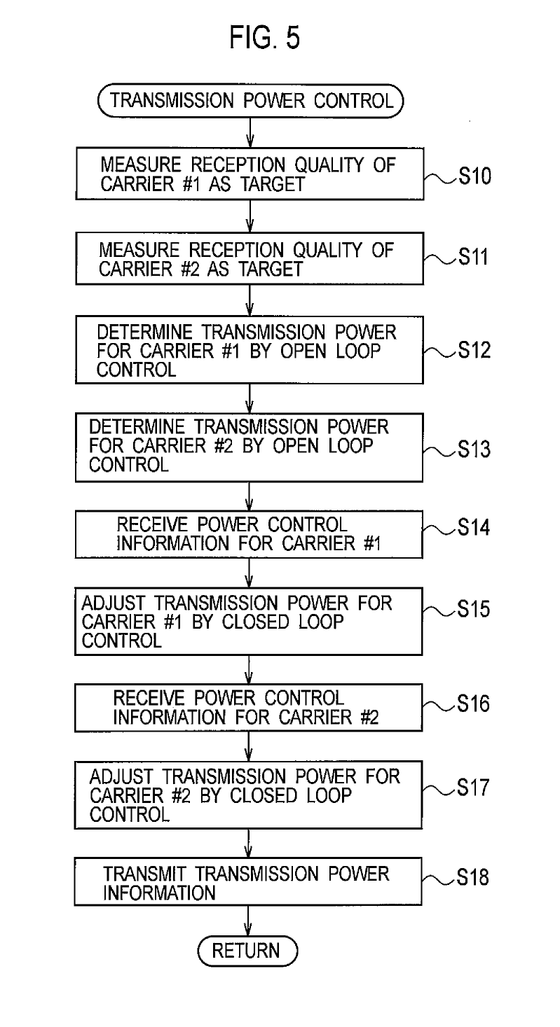

The operation of the radio communication terminal according to the first embodiment of the present invention will be described hereinafter with reference to the drawings. FIG. 5 is a flowchart of the operation of the radio communication terminal 10 according to the first embodiment of the present invention. Note that a main processing of controlling transmission power is repeatedly performed in a predetermined cycle.

Hereinafter, the case where adjacent carriers are the carrier #1 and the carrier #2 will be described as an example. In addition, the radio communication terminal 10 transmits reverse link data to the radio base station 100a by using the carrier #1 and transmits reverse link data to the radio base station 100b by using the carrier #2.

As shown in FIG. 5, in step 10, the radio communication terminal 10 measures reception quality of forward link data as the carrier #1 being the target. Specifically, the radio communication terminal 10 measures the reception quality of forward link data received from the radio base station 100a to which reverse link data is to be transmitted by using the carrier #1.

In step 11, the radio communication terminal 10 measures reception quality of forward link data as the carrier #2 being the target. Specifically, the radio communication terminal 10 measures the reception quality of forward link data received from the radio base station 100b to which reverse link data is to be transmitted by using the carrier #2.

In step 12, the radio communication terminal 10 determines transmission power of the reverse link data to be transmitted by using the carrier #1, through the open loop control. Specifically, the radio communication terminal 10 determines the transmission power of the reverse link data to be transmitted by using the carrier #1, on the basis of the reception quality measured in step 10.

In step 13, the radio communication terminal 10 determines transmission power of the reverse link data to be transmitted by using the carrier #2, through the open loop control. Specifically, the radio communication terminal 10 determines the transmission power of the reverse link data to be transmitted by using the carrier #2, on the basis of the reception quality measured in step 11.

In step 14, the radio communication terminal 10 receives power control information for the carrier #1. Specifically, the radio communication terminal 10 receives the power control information from the radio base station 100a to which reverse link data is transmitted by using the carrier #1. Note that the power control information is information that the radio base station 100a generates on the basis of the reception quality of the reverse link data transmitted by using the carrier #1.

In step 15, the radio communication terminal 10 adjusts the transmission power of the reverse link data to be transmitted by using the carrier #1 through the closed loop control. Specifically, the radio communication terminal 10 adjusts the transmission power of the reverse link data determined in step 12, on the basis of the power control information received in step 14.

Specifically, the radio communication terminal 10 transmits the reverse link data by using the carrier #1 with the transmission powers determined through the open loop control and the closed loop control, respectively.

In step 16, the radio communication terminal 10 receives power control information for the carrier #2. Specifically, the radio communication terminal 10 receives the power control information from the radio base station 100b to which reverse link data is transmitted by using the carrier #2. Note that the power control information is information that the radio base station 100b generates on the basis of the reception quality of the reverse link data transmitted by using the carrier #2.

In step 17, the radio communication terminal 10 adjusts the transmission power of the reverse link data to be transmitted by using the carrier #2, through the closed loop control. Specifically, the radio communication terminal 10 adjusts the transmission power of the reverse link data determined in step 13, on the basis of the power control information received in step 16.

Specifically, the radio communication terminal 10 transmits the reverse link data by using the carrier #2 with the transmission powers determined through the open loop control and the closed loop control, respectively.

In step 18, the radio communication terminal 10 transmits the transmission power information including the transmission power value of the carrier #1 to the base station controller 200 via the radio base station 100a. In addition, the radio communication terminal 10 transmits the transmission power information including the transmission power value of the carrier #2 to the base station controller 200 via the radio base station 100b.

### (Operation of Base Station Controller)

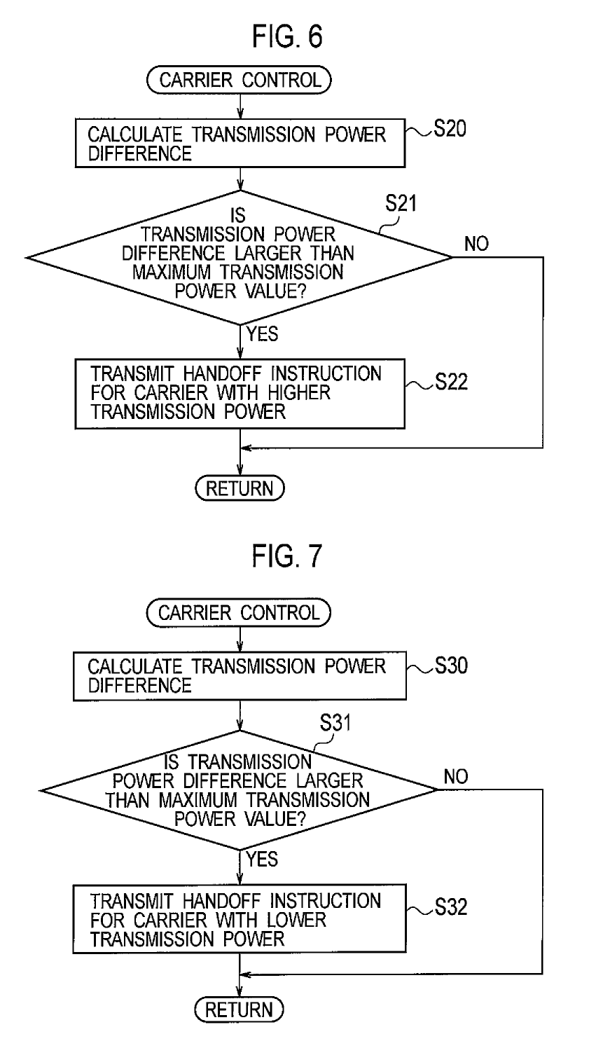

The operation of the base station controller according to the first embodiment of the present invention will be described hereinafter with reference to the drawings. FIGS. 6 and 7 are flowcharts showing operation of the base station controller 200 according to the first embodiment of the present invention. Specifically, FIGS. 6 and 7 are flow charts showing a processing (carrier control processing) of controlling a carrier used by the radio communication terminal 10 for transmitting reverse link data, the processing being performed by the base station controller 200.

First, a carrier control processing (1) will be described with reference to FIG. 6. As shown in FIG. 6, in step 20, the base station controller 200 receives transmission power information including transmission power values of adjacent carriers (carrier 41 and carrier #2) from the radio base stations 100. Subsequently, the base station controller 200 calculates a difference in transmission power (transmission power difference) of reverse link data between the adjacent carriers (carrier #1 and carrier #2).

In step 21, the base station controller 200 determines whether or not the transmission power difference between the adjacent carriers exceeds a threshold set on the basis of a maximum transmission power difference (MaxRLTxPwrDiff). When the transmission power difference between the adjacent carriers exceeds the threshold set on the basis of the maximum transmission power difference, the base station controller 200 proceeds to the processing in step S22. When the transmission power difference between the adjacent carriers does not exceed the threshold set on the basis of the maximum transmission power difference, the base station controller 200 terminates the carrier control processing.

The threshold to be set on the basis of the maximum transmission power difference may be the maximum transmission power difference itself, or may be a value smaller than the maximum transmission power difference (for example, a value obtained by multiplying the maximum transmission power difference by a predetermined ratio (0.9)).

In step 22, the base station controller 200 transmits a handoff instruction for one of the adjacent carriers that has higher transmission power to a radio base station 100 connected to the radio communication terminal 10 via the carrier with higher transmission power.

Next, a carrier control processing (2) will be described with reference to FIG. 7. Note that the carrier control processing (2) is performed instead of the aforementioned carrier control processing (1).

As shown in FIG. 7, in step 30, the base station controller 200 receives transmission power information including transmission power values of the adjacent carriers (carrier #1 and carrier #2) from the radio base stations 100. Subsequently, the base station controller 200 calculates a difference in transmission power (transmission power difference) of reverse link data between the adjacent carriers (carrier #1 and carrier #2).

In step 31, the base station controller 200 determines whether or not the transmission power difference between the adjacent carriers exceeds a threshold set on the basis of a maximum transmission power difference (MaxRLTxPwrDiff). When the transmission power difference between the adjacent carriers exceeds the threshold set on the basis of the maximum transmission power difference, the base station controller 200 proceeds to the processing in step 32. When the transmission power difference between the adjacent carriers does not exceed the threshold set on the basis of the maximum transmission power difference, the base station controller 200 terminates a sub-processing of transmission power control.

The threshold to be set on the basis of the maximum transmission power difference may be the maximum transmission power difference itself, or may be a value smaller than the maximum transmission power difference (for example, a value obtained by multiplying the maximum transmission power difference by a predetermined ratio (0.9)).

In step 32, the base station controller 200 transmits a handoff instruction for one of the adjacent carriers that has lower transmission power to a radio base station 100 connected to the radio communication terminal 10 via the carrier with lower transmission power.

### (Action and Effect)

With the base station controller 200 according to the first embodiment of the present invention, when a transmission power difference between adjacent carriers exceeds a threshold set on the basis of a maximum transmission power difference, the handoff instruction transmitter 230 transmits a handoff instruction to the radio base station 100 connected to the radio communication terminal 10 via any one of the adjacent carriers, the handoff instruction being for the carrier. Thus, the transmission power difference between the adjacent carriers can be maintained within the maximum transmission power difference.

Thus, communications by multicarrier can be maintained while interference between adjacent carriers which are adjacent to each other with a predetermined frequency interval is controlled.

### Second Embodiment

A second embodiment of the present invention will be described hereinafter. In the following, differences between the first embodiment described above and the second embodiment will be mainly described.

Specifically, in the first embodiment described above, the base station controller 200 transmits a handoff instruction for any one of adjacent carriers when the transmission power difference between the adjacent carriers exceeds a threshold set on the basis of a maximum transmission power difference.

Different from this, in the second embodiment, the base station controller 200 determines whether or not the transmission power difference between adjacent carriers is increasing. Then, the base station controller 200 transmits a handoff instruction for any one of the adjacent carriers when the transmission power difference between the adjacent carriers is increasing, and also, the transmission power difference between the adjacent carriers exceeds a threshold set on the basis of a maximum transmission power difference.

### (Configuration of Base Station Controller)

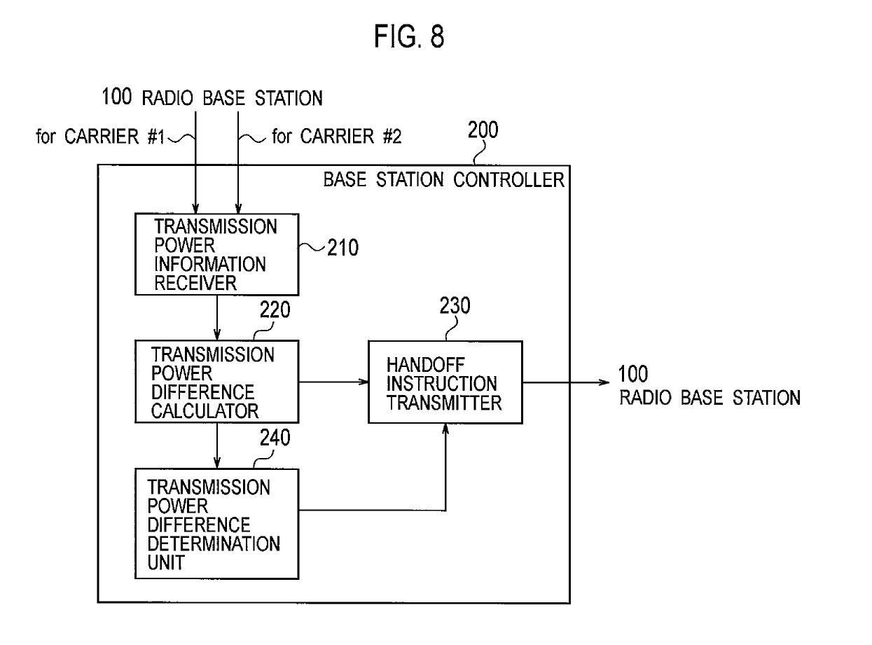

A configuration of the base station controller according to the second embodiment of the present invention will be described hereinafter with reference to the drawings. FIG. 8 is a functional block configuration diagram showing the base station controller 200 according to the second embodiment of the present invention. It should be noted that in FIG. 8, similar reference numerals are assigned to the configuration similar to FIG. 4.

As shown in FIG. 8, the base station controller 200 includes a transmission power difference determination unit 240 in addition to a transmission power information receiver 210, a transmission power difference calculator 220 and a handoff instruction transmitter 230.

The transmission power difference calculator 220 calculates a transmission power difference between adjacent carriers in a predetermined cycle (cycle in which the transmission power information receiver 210 receives transmission power information, for example).

The transmission power difference determination unit 240 determines whether or not the transmission power difference between the adjacent carriers is increasing, the difference calculated by the transmission power difference calculator 220 in the predetermined cycle. Specifically, on the basis of the transmission power of the reverse link data, the transmission power difference determination unit 240 calculates an expression of an estimated curve (hereinafter referred to as an estimated curve expression) for each of the adjacent carriers, the estimated curve expression showing a state in which the transmission power of the reverse link data changes on the time axis. Subsequently, the transmission power difference determination unit 240 determines whether or not a difference in values calculated by each of the estimated curve expressions (hereinafter referred to as an estimated curve difference) at a predetermined time exceeds an estimated curve difference threshold for a predetermined period. When the estimated curve difference between the adjacent carriers exceeds the estimated curve threshold for the predetermined period, the transmission power difference determination unit 240 informs the handoff instruction transmitter 230 that the estimated curve difference between the adjacent carriers exceeds the estimated curve threshold for the predetermined period.

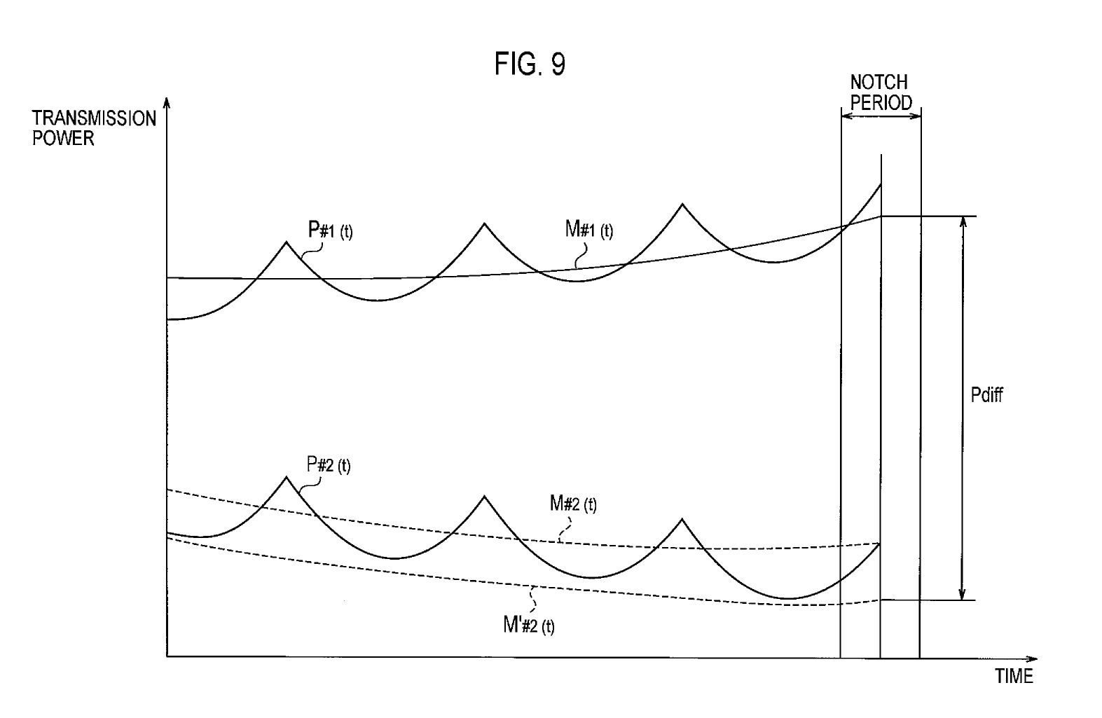

For example, using the case where adjacent carriers are a carrier #1 and a carrier #2 as an example, the procedure for calculating an estimated curve difference between the carrier #1 and the carrier #2 will be described with reference to FIG. 9. Hereinafter, considered is the case where transmission power of the carrier #1 is larger than that of the carrier #2.

Note that a notch period is determined by notch intervals calculated on the basis of reception strength or reception quality (SIR). Specifically, the notch period includes a notch interval before the peak point of a transmission power estimation curve and a notch interval after the peak point thereof. Here, the base station controller 200 transmits a handoff instruction for any one of adjacent carriers when the estimated curve difference between the adjacent carriers exceeds the estimated curve threshold for the predetermined period in the notch period.

Specifically, when the transmission power of the carrier #1 at time t is set as “P_{#1}(t)”, an estimated curve expression “M_{#1}(t)” of the carrier #1 is calculated by the following expression (1) where α is a coefficient corresponding to the carrier #1:

[Formula 1]

M_{#1}(t)=α×P_{#1}(t)+(1−α)×M_{#1}(t−Δt) Expression (1)

On the other hand, when the transmission power of the carrier #2 at the time t is set as “P_{#2}(t)”, an estimated curve expression “M_{#2} (t)” of the carrier #2 is calculated by the following expression (2) where β is a coefficient corresponding to the carrier #2:

[Formula 2]

M_{#2}(t)=β×P_{#2}(t)+(1−β)×M_{#2}(t−Δt) Expression (2)

Furthermore, for the carrier #2 having lower transmission power, a lower estimated curve expression “M′_{#2}(t)” of the carrier #2 is calculated by the following expression (3):

[Formula 3]

M′_{#2}(t)=M_{#2}(t)−max{M_{#2}(t+Δt)−P_{#2}(t+Δt)} Expression (3)

In addition, at the time t, a difference (estimated curve difference “P_{diff}”) between a value calculated by the estimated curve expression of the carrier #1 and a value calculated by the lower estimated curve expression of the carrier #2 is calculated by the following expression (4):

[Formula 4]

P_{diff}=M_{#1}(t)−M′_{#2}(t) Expression (4)

Subsequently, the transmission power difference determination unit 240 determines whether or not the estimated curve difference “P_{diff}” calculated by the expression (1) to the expression (4) exceeds the estimated curve difference threshold (Pₜₕᵣₑₛₕ) for a predetermined period.

It is needless to say that an estimated curve difference “P_{diff}” may simply be a difference between a value calculated by the estimated curve expression “M_{#1}(t)” and a value calculated by the estimated curve expression “M_{#2}(t)”, not a difference between a value calculated by the estimated curve expression “M_{#1}(t)” and a value calculated by the lower estimated curve expression “M′_{#2}(t)”.

Note that the transmission power difference determination unit 240 may determine whether or not the estimated curve difference “P_{diff}” exceeds the estimated curve difference threshold (Pₜₕᵣₑₛₕ) during the notch period.

When informed that an estimated curve difference between adjacent carriers has exceeded an estimated curve threshold for a predetermined period and that a transmission power difference between the adjacent carriers has exceeded a threshold set on the basis of a maximum transmission power difference, the handoff instruction transmitter 230 transmits a handoff instruction for any one of the adjacent carriers.

### (Operation of Base Station Controller)

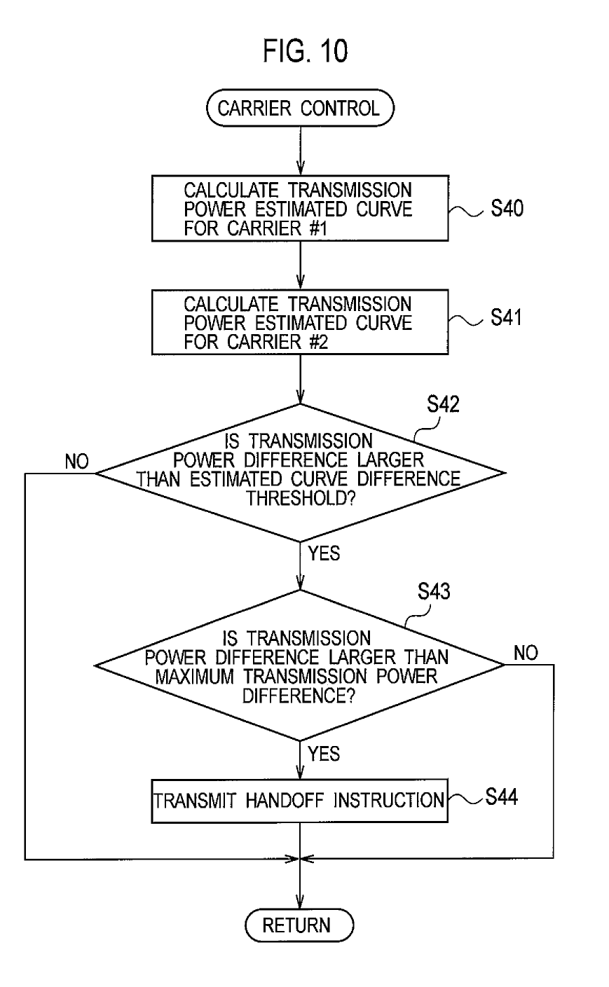

The operation of the base station controller according to the second embodiment of the present invention will be described hereinafter with reference to the drawings. FIG. 10 is a flowchart of the operation of the base station controller 200 according to the second embodiment of the present invention. Note that the carrier control processing shown in FIG. 10 is performed instead of the aforementioned carrier control processing shown in FIGS. 6 and 7.

Hereinafter, as is the case of the first embodiment as described above, the case where adjacent carriers are a carrier #1 and a carrier #2 will be described as an example. In addition, the radio communication terminal 10 is assumed to transmit reverse link data to the radio base station 100a by using the carrier #1 and transmit reverse link data to the radio base station 100b by using the carrier #2. Furthermore, transmission power of the carrier #1 is assumed to be larger than that of the carrier #2.

As shown in FIG. 10, in step 40, the base station controller 200 receives transmission power information including a transmission power value of the carrier #1 from the radio base station 100a. Subsequently, the base station controller 200 calculates an estimated curve expression of the carrier #1 on the basis of the transmission power of the reverse link data to be transmitted via the carrier #1 with higher transmission power.

In step 41, the base station controller 200 receives transmission power information including a transmission power value of the carrier #2 from the radio base station 100b. The base station controller 200 calculates an estimated curve expression (or a lower estimated curve expression) of the carrier #2 on the basis of the transmission power of the reverse link data to be transmitted via the carrier #2 with lower transmission power.

In step 42, based on the estimated curve expression of the carrier #1 calculated in step 40 and the estimated curve expression (or the lower estimated curve expression) of the carrier #2 calculated in step 41, the base station controller 200 determines whether or not a transmission power difference between the carrier #1 and the carrier #2 has exceeded the estimated curve difference threshold. Specifically, the base station controller 200 calculates a difference (estimated curve difference) between a value calculated by the estimated curve expression of the carrier #1 and a value calculated by the estimated curve expression (or the lower estimated curve expression) of the carrier #2. Subsequently, the base station controller 200 determines whether or not the estimated curve difference has exceeded an estimated curve difference threshold for a predetermined period.

When determining that the estimated curve difference has exceeded the estimated curve difference threshold for the predetermined period, the base station controller 200 proceeds to the processing of step 43. On the other hand, when determining the estimated curve difference has not exceeded the estimated curve difference threshold for the predetermined period, the base station controller 200 terminates the carrier control processing.

In step 43, the base station controller 200 determines whether or not the transmission power difference between the carrier #1 and the carrier #2 exceeds a threshold set on the basis of a maximum transmission power difference. When the transmission power difference exceeds the threshold set on the basis of the maximum transmission power difference, the base station controller 200 proceeds to the processing of step 44. When the transmission power difference does not exceed the threshold set on the basis of the maximum transmission power difference, the base station controller 200 terminates the carrier control processing.

In step 44, the base station controller 200 transmits a handoff instruction to the radio base station 100 to which any one of the adjacent carriers is connected, the handoff instruction being for the carrier.

### (Action and Effect)

With the base station controller 200 according to the second embodiment of the present invention, the handoff instruction transmitter 230 transmits a handoff instruction for one of adjacent carriers, not simply in the case where a transmission power difference between the adjacent carriers exceeds a threshold set on the basis of a maximum transmission power difference. The handoff instruction transmitter 230 transmits a handoff instruction for one of the adjacent carriers in the case where the transmission power difference between the adjacent carriers exceeds an estimated curve difference threshold for a predetermined period, and also the transmission power difference between the adjacent carriers exceeds the threshold set on the basis of the maximum transmission power difference.

Now, considered is a case where transmission power of the carrier temporarily increases through the open loop control or the closed loop control, as a result of deterioration of reception quality due to effect of fading or the like. In such a case, even if the transmission power difference between the adjacent carriers temporarily exceeds a threshold set on the basis of a maximum transmission power difference, the transmission power difference between the adjacent carriers is likely to fall within the maximum transmission power difference when the effect of fading or the like is eliminated.

In the second embodiment of the present invention, unnecessary transmission of a handoff instruction can be prevented in the aforementioned case where the transmission power difference between the adjacent carriers temporarily exceeds the threshold set on the basis of the maximum transmission power difference.

### Third Embodiment

Next, a third embodiment of the present invention will be described hereinafter. Note that since an overall schematic configuration and a reverse link frequency band of the communication system according to the third embodiment of the present invention are same as those in the first embodiment, the description thereof is omitted herein.

### (Configuration of Radio Communication Terminal)

A configuration of the radio communication terminal according to the third embodiment of the present invention will be described hereinafter with reference to the drawings.

As shown in FIG. 3, the radio communication terminal according to the third embodiment includes an antenna 11, an RF/IF converter 12, a power amplifier 13, a voice input/output unit 14, an image input/output unit 15, a codec processor 16, a baseband processor 17, an operator 18, a memory 19 and a controller 20, as in the case of the radio communication terminal according to the first embodiment. Since the functions of the antenna 11, the RF/IF converter 12, the power amplifier 13, the voice input/output unit 14, the image input/output unit 15, the codec processor 16, the baseband processor 17 and the operator 18 are same as those in the first embodiment, the description thereof is omitted herein.

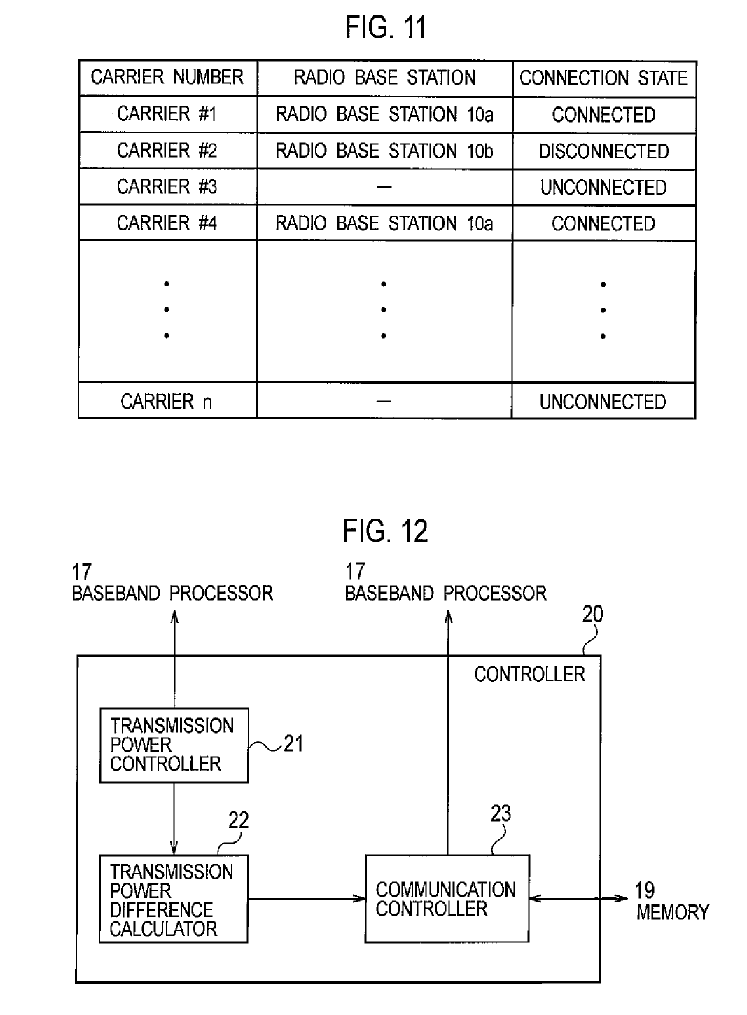

As shown in FIG. 11, the memory 19 includes a table in which a carrier number, a radio base station and a connection state are associated with each other.

In a “carrier number” field, a number assigned to a carrier for identifying each carrier is stored.

In a “radio base station” field, information for identifying a radio base station connected to the radio communication terminal 10 via each carrier (for example, the name) is stored. Note that a combination of a carrier number and a radio base station is not static and is changed in accordance with reception quality of forward link data, or the like.

In a “connection state” field, information indicating a connection state of each carrier (“connected,” “disconnected” or “unconnected”) is stored. “Connected” indicates that the radio base station 100 in the “radio base station” field is connected to the radio communication terminal 10 via the carrier shown in the “carrier number” field. “Disconnected” indicates that the carrier in the “carrier number” field is disconnected. “Unconnected” indicates that the carrier in the “carrier number” field is not connected. Note that the information in a “connection state” field is rewritten from “disconnected” to “unconnected,” when a certain period of time passes after the carrier in the “carrier number” field is disconnected.

The controller 20 controls the operation of the radio communication terminal 10 (image input/output unit 15, codec processor 16, baseband processor 17 and the like) in accordance with programs stored in the memory 19.

Hereinafter, a configuration of the controller according to the third embodiment of the present invention will be described with reference to the drawings. FIG. 12 is a functional block configuration diagram showing the controller 20 according to the first embodiment of the present invention.

As shown in FIG. 12, the controller 20 includes a transmission power controller 21, a transmission power difference calculator 22 and a communication controller 23.

The transmission power controller 21 controls transmission power of reverse link data for each carrier. Specifically, the transmission power controller 21 controls the transmission power of the reverse link data on the basis of reception quality (SIR, for example) of forward link data received from the radio base station 100 to which the reverse link data is transmitted (open loop control).

The transmission power controller 21 also controls transmission power of reverse link data on the basis of power control information received from the radio base station 100 to which the reverse link data is transmitted (closed loop control). Note that the power control information is, as described above, information that the radio base station 100 generates on the basis of reception quality (SIR, for example) of the reverse link data. The power control information is information that requests the decrease or the increase of the transmission power for the reverse link data.

The transmission power difference calculator 22 calculates a transmission power difference between adjacent carriers in reverse link data (hereinafter referred to as a transmission power difference). In addition, the transmission power difference calculator 22 determines whether or not a transmission power difference between adjacent carriers exceeds a threshold set on the basis of a maximum transmission power difference (MaxRLTxPwrDiff) allowable between adjacent carriers. When the transmission power difference between the adjacent carriers exceeds the threshold set on the basis of the maximum transmission power difference, the transmission power difference calculator 22 informs the communication controller 23 that the transmission power difference between the adjacent carriers has exceeded the threshold set on the basis of the maximum transmission power difference.

Here, the threshold to be set on the basis of the maximum transmission power difference may be the maximum transmission power difference itself, or may be a value smaller than the maximum transmission power difference (for example, a value obtained by multiplying the maximum transmission power difference by a predetermined ratio (0.9)).

When informed that the transmission power difference between adjacent carriers exceeds the threshold set on the basis of the maximum transmission power difference, the communication controller 23 transmits a handoff request for requesting handoff of any one of the adjacent carriers to the radio base station 100 connected via the carrier for which the handoff is requested.

Note that, among adjacent carriers, a carrier for which handoff is requested is termed as a “handoff target carrier,” and a carrier for which handoff is not requested is termed as a “non-handoff target carrier.”

When transmitting a handoff request to the radio base station 100, the communication controller 23 selects a radio base station 100 to be the handoff destination from radio base stations 100 located around the radio communication terminal 10, and selects a carrier to be used for transmitting reverse link data. Note that the communication controller 23 includes, in the handoff request, information indicating the radio base station 100 to be the handoff destination and the carrier to be used for transmitting the reverse link data, and then transmit the handoff request to the radio base station 100.

Specifically, the communication controller 23 measures reception quality (SIR, for example) of forward link data transmitted from the radio base stations 100 located around the radio communication terminal 10. The communication controller 23 selects, on the basis of the measured reception quality, a radio base station 100 to which the radio communication terminal 10 is to be connected. For example, the communication controller 23 calculates a difference between reception quality of forward link data transmitted from the radio base station 100 connected to the radio communication terminal 10 via a non-handoff target carrier and reception quality of forward link data transmitted from each of the radio base stations 100 located around the radio communication terminal 10 (reception quality difference). The communication controller 23 selects a radio base station 100 that transmits forward link data with reception quality whose reception quality difference is within a predetermined range to be the handoff destination.

Here, the communication controller 23 refers to the table stored in the memory 19 and removes a radio base station 100 whose information in the “connection state” field shows “disconnected” from the radio base stations 100 to be the handoff target.

Subsequently, the communication controller 23 refers to the table stored in the memory 19 and selects a carrier to be used for transmitting the reverse link data among carriers whose information in the fields of “connection state” show “unused” or “disconnected.” For example, the radio communication terminal 10 selects a carrier having a center frequency most distant from that of a carrier whose information in the “connection state” field shows “connected.”

Furthermore, the radio communication terminal 10 may select a carrier with transmission power close to transmission power of the carrier whose information in the “connection state” field shows “connected.”

### (Operation of Radio Communication Terminal)

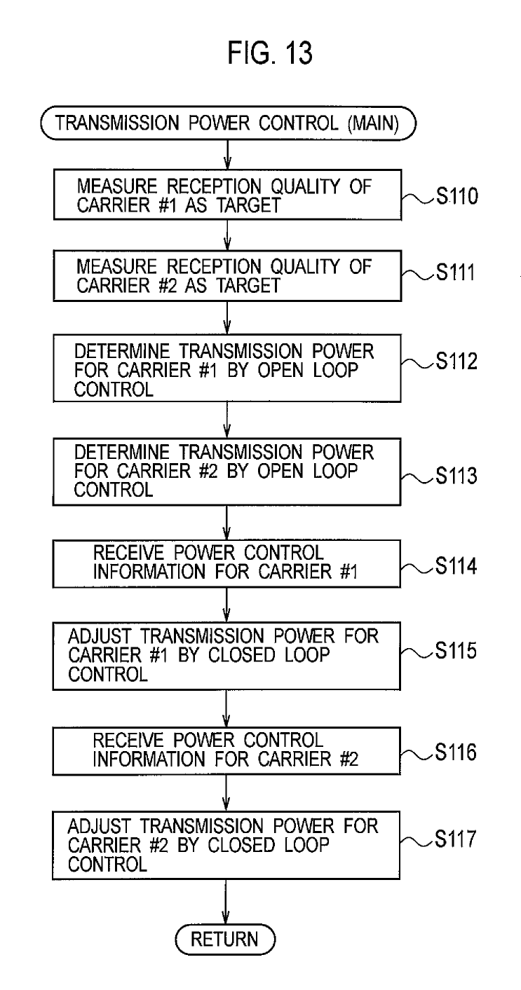

The operation of the radio communication terminal according to the third embodiment of the present invention will be described hereinafter with reference to the drawings. FIGS. 13 to 16 are flowcharts of the operation of the radio communication terminal 10 according to the third embodiment of the present invention.

Hereinafter, the case where adjacent carriers are a carrier #1 and a carrier #2 will be described as an example. In addition, the radio communication terminal 10 transmits reverse link data to the radio base station 100a by using the carrier #1 and transmits reverse link data to the radio base station 100b by using the carrier #2.

First, a main processing of controlling transmission power will be described with reference to FIG. 13. The main processing of controlling transmission power is repeatedly performed in a predetermined cycle.

As shown in FIG. 13, in step 110, the radio communication terminal 10 measures reception quality of forward link data as the carrier #1 being the target. Specifically, the radio communication terminal 10 measures the reception quality of forward link data received from the radio base station 100a to which reverse link data is to be transmitted by using the carrier #1.

In step 111, the radio communication terminal 10 measures reception quality of forward link data as the carrier #2 being the target. Specifically, the radio communication terminal 10 measures the reception quality of forward link data received from the radio base station 100b to which reverse link data is to be transmitted by using the carrier #2.

In step 112, the radio communication terminal 10 determines transmission power of the reverse link data to be transmitted by using the carrier #1, through the open loop control. Specifically, the radio communication terminal 10 determines the transmission power of the reverse link data to be transmitted by using the carrier #1, on the basis of the reception quality measured in step 110.

In step 113, the radio communication terminal 10 determines transmission power of the reverse link data to be transmitted by using the carrier #2, through the open loop control. Specifically, the radio communication terminal 10 determines the transmission power of the reverse link data to be transmitted by using the carrier #2, on the basis of the reception quality measured in step 111.

In step 114, the radio communication terminal 10 receives power control information for the carrier #1. Specifically, the radio communication terminal 10 receives the power control information from the radio base station 100a to which reverse link data is transmitted by using the carrier #1. Note that the power control information is information that the radio base station 100a generates on the basis of the reception quality of the reverse link data transmitted by the carrier #1.

In step S115, the radio communication terminal 10 adjusts the transmission power of the reverse link data to be transmitted by using the carrier #1 through the closed loop control. Specifically, the radio communication terminal 10 adjusts the transmission power of the reverse link data determined in step 112 on the basis of the power control information received in step 114.

Specifically, the radio communication terminal 10 transmits the reverse link data by using the carrier #1 with the transmission powers determined through the open loop control and the closed loop control, respectively.

In step 116, the radio communication terminal 10 receives power control information for the carrier #2. Specifically, the radio communication terminal 10 receives the power control information from the radio base station 100b to which reverse link data is transmitted by using the carrier #2. Note that the power control information is information that the radio base station 100b generates on the basis of the reception quality of the reverse link data transmitted by using the carrier #2.

In step 117, the radio communication terminal 10 adjusts the transmission power of the reverse link data to be transmitted by using the carrier #2, through the closed loop control. Specifically, the radio communication terminal 10 adjusts the transmission power of the reverse link data determined in step 113 on the basis of the power control information received in step 116.

Specifically, the radio communication terminal 10 transmits the reverse link data by using the carrier #2 with the transmission powers determined through the open loop control and the closed loop control, respectively.

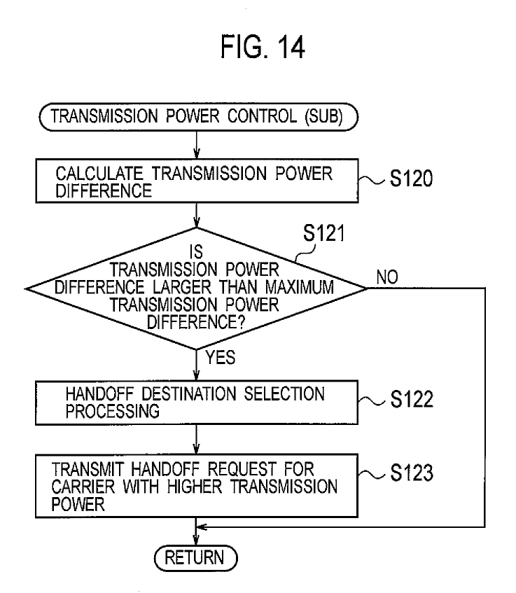

Hereinafter, a sub-processing (1) of controlling transmission power will be described with reference to FIG. 14. Note that the sub-processing (1) of controlling transmission power is a processing which breaks into the main processing of controlling transmission power in a predetermined cycle.

As shown in FIG. 14, in step 120, the radio communication terminal 10 calculates a difference in transmission power (transmission power difference) of reverse link data between adjacent carriers (carrier #1 and carrier #2).

In step 121, the radio communication terminal 10 determines whether or not the transmission power difference between the adjacent carriers exceeds a threshold set on the basis of a maximum transmission power difference (MaxRLTxPwrDiff). When the transmission power difference between the adjacent carriers exceeds the threshold set on the basis of the maximum transmission power difference, the radio communication terminal 10 proceeds to the processing in step 122. In addition, when the transmission power difference between the adjacent carriers does not exceed the threshold set on the basis of the maximum transmission power difference, the radio communication terminal 10 terminates the sub-processing of controlling transmission power.

The threshold to be set on the basis of the maximum transmission power difference herein may be the maximum transmission power difference itself, or may be a value smaller than the maximum transmission power difference (for example, a value obtained by multiplying the maximum transmission power difference by a predetermined ratio (0.9)).

In step 122, the radio communication terminal 10 selects a radio base station 100 to be the handoff destination from radio base stations 100 located around the radio communication terminal 10, and selects a carrier to be used for transmitting reverse link data (handoff destination selection processing). Note that the handoff destination selection processing will be described later in detail (refer to FIG. 16).

In step 123, the radio communication terminal 10 transmits a handoff request for requesting handoff of one of the adjacent carriers that has higher transmission power to the radio base station 100 to which the carrier with the higher transmission power is connected. The handoff request herein includes the information indicating the radio base station 100 and the carrier, which are selected in step 122.

Note that the radio base station 100 having received the handoff request instructs the radio base station 100 indicated by the information included in the handoff request to connect to the radio communication terminal 10 via the carrier indicated by the information included in the handoff request.

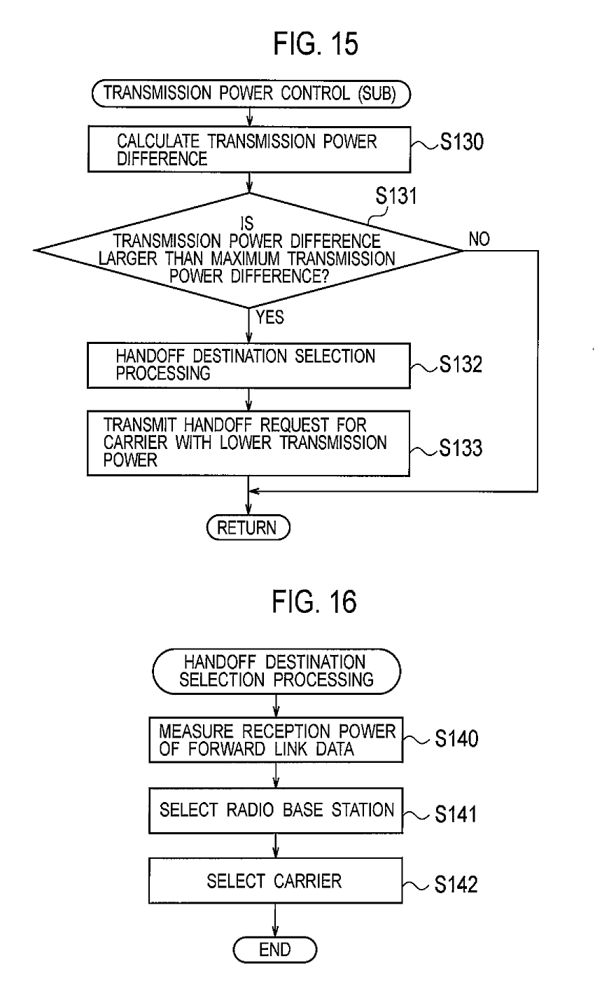

Next, a sub-processing (2) of controlling transmission power will be described with reference to FIG. 15. Note that the sub-processing (2) of controlling transmission power is a processing which breaks into the main processing of controlling transmission power in a predetermined cycle as in the case of the sub-processing (1) of controlling transmission power.

As shown in FIG. 15, in step 130, the radio communication terminal 10 calculates a difference in transmission power (transmission power difference) of reverse link data between adjacent carriers (carrier #1 and carrier #2).

In step 131, the radio communication terminal 10 determines whether or not the transmission power difference between the adjacent carriers exceeds a threshold set on the basis of a maximum transmission power difference (MaxRLTxPwrDiff). When the transmission power difference between the adjacent carriers exceeds the threshold set on the basis of the maximum transmission power difference, the radio communication terminal 10 proceeds to the processing in step 132. In addition, when the transmission power difference between the adjacent carriers does not exceed the threshold set on the basis of the maximum transmission power difference, the radio communication terminal 10 terminates the sub-processing of controlling transmission power.

The threshold to be set on the basis of the maximum transmission power difference herein may be the maximum transmission power difference itself, or may be a value smaller than the maximum transmission power difference (for example, a value obtained by multiplying the maximum transmission power difference by a predetermined ratio (0.9)).

In step 132, the radio communication terminal 10 selects a radio base station 100 to be the handoff destination from radio base stations 100 located around the radio communication terminal 10, and selects a carrier to be used for transmitting reverse link data (handoff destination selection processing). Note that the handoff destination selection processing will be described later in detail (refer to FIG. 16).

In step 133, the radio communication terminal 10 transmits a handoff request for requesting handoff of one of the adjacent carriers that has lower transmission power to the radio base station 100 to which the carrier with lower transmission power is connected. The handoff request herein includes the information indicating the radio base station 100 and the carrier, which are selected in step 132.

Note that the radio base station 100 having received the handoff request instructs the radio base station 100 indicated by the information included in the handoff request to connect to the radio communication terminal 10 via the carrier indicated by the information included in the handoff request.

Lastly, the handoff destination selection processing shown in FIGS. 14 and 15 will be described in detail with reference to FIG. 16.

As shown in FIG. 16, in step 140, the radio communication terminal 10 measures reception quality (SIR, for example) of forward link data transmitted from the radio base stations 100 located around the radio communication terminal 10.

In step 141, on the basis of the reception quality measured in step 140, the radio communication terminal 10 selects a radio base station 100 to which the radio communication terminal 10 is to be connected. For example, the radio communication terminal calculates a difference between reception quality of forward link data transmitted from the radio base station 100 connected to the radio communication terminal 10 via a non-handoff target carrier and reception quality of forward link data transmitted from each of the radio base stations 100 located around the radio communication terminal 10 (reception quality difference). The communication controller 23 selects a radio base station 100 transmitting forward link data with reception quality whose reception quality difference is within a predetermined range to the handoff destination.

Here, the radio communication terminal 10 refers to the table stored in the memory 19 and removes a radio base station 100 whose information in the “connection state” field shows “disconnected,” from the radio base stations 100 to which the radio communication terminal 10 is to be connected.

In step 142, the radio communication terminal 10 refers to the table stored in the memory 19 and selects a carrier to be used for transmitting the reverse link data among the carriers whose information in the “connection state” fields show “unused” or “disconnected.” For example, the radio communication terminal 10 selects a carrier having a center frequency most distant from that of the carrier whose information in the “connection state” field shows “connected.”

Furthermore, the radio communication terminal 10 may select a carrier with transmission power close to transmission power of the carrier whose information in the “connection state” field shows “connected.”

### (Action and Effect)

With the radio communication terminal 10 according to the third embodiment of the present invention, the communication controller 23 transmits a handoff request for a carrier with higher transmission power to a radio base station 100 connected to the radio communication terminal 10 via the carrier with the higher transmission power in a case where a transmission power difference between the adjacent carriers exceeds a threshold set on the basis of a maximum transmission power difference (MaxRLTxPwrDiff).

Moreover, with the radio communication terminal 10 according to the third embodiment of the present invention, the communication controller 23 transmits a handoff request for a carrier with lower transmission power to a radio base station 100 connected to the radio communication terminal 10 via the carrier with the lower transmission power in a case where a transmission power difference between the adjacent carriers exceeds a threshold set on the basis of a maximum transmission power difference (MaxRLTxPwrDiff).

Thus, communications by multicarrier can be maintained while interference between adjacent carries that are adjacent to each other with a predetermined frequency interval is controlled.

Moreover, with the radio communication terminal 10 according to the third embodiment of the present invention, the communication controller 23 includes, in the handoff request, information indicating a radio base station 100 to be the handoff destination and a carrier to be used for transmitting reverse link data.

In this case, the communication controller 23 refers to the table stored in the memory 19, and removes a radio base station 100 whose information in the “connection state” field shows “disconnected,” from the radio base stations 100 to which the radio communication terminal 10 is to be connected. Thus, a possibility that a transmission power difference exceeds a threshold set on the basis of a maximum transmission power difference when the radio communication terminal 10 is connected to the radio base station 100 via a new carrier can be reduced.

In addition, since the communication controller 23 selects a radio base station 100 to be the handoff destination on the basis of reception quality of forward link data, a possibility that a transmission power difference exceeds the threshold set on the basis of the maximum transmission power difference when the radio communication terminal 10 is connected to the radio base station 100 via a new carrier can be reduced.

### Fourth Embodiment

A fourth embodiment of the present invention will be described hereinafter. In the following, differences between the third embodiment described above and the fourth embodiment will be mainly described.

Specifically, in the aforementioned third embodiment, the radio communication terminal 10 transmits a handoff request for requesting handoff of any one of adjacent carriers in a case where a transmission power difference between the adjacent carriers exceeds a threshold set on the basis of a maximum transmission power difference.

Different from this, in the fourth embodiment, the radio communication terminal 10 determines whether or not a transmission power difference between adjacent carriers is increasing. Then, the radio communication terminal 10 transmits a handoff request for requesting handoff of any one of the adjacent carriers when the transmission power difference between the adjacent carriers is increasing and also the transmission power difference between the adjacent carriers exceeds the threshold set on the basis of the maximum transmission power difference.

### (Configuration of Radio Communication Terminal)

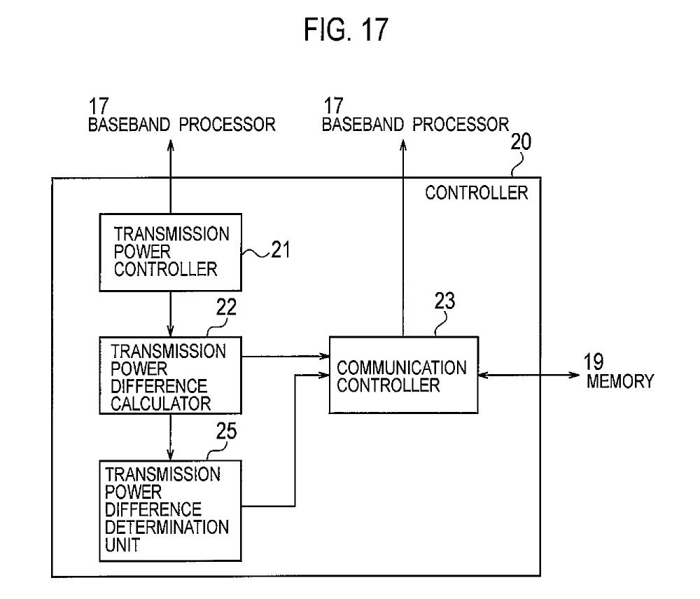

A configuration of the radio communication terminal according to the fourth embodiment of the present invention will be described hereinafter with reference to the drawings. FIG. 17 is a block configuration diagram showing a controller 20 of the radio communication terminal 10 according to the fourth embodiment of the present invention. It should be noted that in FIG. 17, similar reference numerals are assigned to the configuration similar to FIG. 12.

As shown in FIG. 17, the radio communication terminal 10 includes a transmission power difference determination unit 25 in addition to a transmission power controller 21, a transmission power difference calculator 22, and a communication controller 23.

The transmission power difference calculator 22 calculates a transmission power difference between adjacent carriers in a predetermined cycle (cycle in which the transmission power controller 21 performs transmission power control, for example).

The transmission power difference determination unit 25 determines whether or not the transmission power difference between the adjacent carriers is increasing, the difference calculated by the transmission power difference calculator 22 in the predetermined cycle. Specifically, on the basis of the transmission power of the reverse link data, the transmission power difference determination unit 25 calculates an expression of an estimated curve (hereinafter referred to as an estimated curve expression) for each of the adjacent carriers, the estimated curve expression showing a state in which transmission power of the reverse link data changes on the time axis. Subsequently, the transmission power difference determination unit 25 determines whether or not a difference in values calculated by each of the estimated curve expressions (hereinafter referred to as an estimated curve difference) at a predetermined time exceeds an estimated curve difference threshold for a predetermined period. When the estimated curve difference between the adjacent carriers exceeds the estimated curve threshold for the predetermined period, the transmission power difference determination unit 25 informs the communication controller 23 that the estimated curve difference between the adjacent carriers exceeds the estimated curve threshold for the predetermined period.

For example, using the case where adjacent carriers are a carrier #1 and a carrier #2 as an example, the procedure for calculating an estimated curve difference between the carrier #1 and the carrier 42 will be described with reference to FIG. 9. Hereinafter, considered is the case where transmission power of the carrier #1 is larger than that of the carrier #2.

Note that a notch period is determined by notch intervals calculated on the basis of reception strength or reception quality (SIR). Specifically, the notch period includes a notch interval before the peak point of a transmission power estimation curve and a notch interval after the peak point thereof. Here, the radio communication terminal 10 transmits a handoff request for requesting handoff of any one of the adjacent carriers when the estimated curve difference between the adjacent carriers exceeds the estimated curve threshold for the predetermined period in the notch period.

Specifically, when the transmission power of the carrier 41 at time t is set as “P_{#1}(t)”, an estimated curve expression “M_{#1}(t)” of the carrier #1 is calculated by the following expression (1) where α is a coefficient corresponding to the carrier #1:

[Formula 1]

M_{#1}(t)=α×P_{#1}(t)+(1−α)×M_{#1}(t−Δt) Expression (1)

On the other hand, when the transmission power of the carrier #2 at the time t is set as “P_{#2}(t)”, an estimated curve expression “M_{#2}(t)” of the carrier #2 is calculated by the following expression (2) where β is a coefficient corresponding to the carrier #2:

[Formula 2]

M_{#2}(t)=β×P_{#2}(t)+(1−β)×M_{#2}(t−Δt) Expression (2)

Furthermore, for the carrier #2 having lower transmission power, a lower estimated curve expression “M′_{#2}(t)” of the carrier #2 is calculated by the following expression (3):

[Formula 3]

M′_{#2}(t)=M_{#2}(t)−max{M_{#2}(t+Δt)−P_{#2}(t+Δt)} Expression (3)

In addition, at the time t, a difference (estimated curve difference “P_{diff}”) between a value calculated by the estimated curve expression of the carrier #1 and a value calculated by the lower estimated curve expression of the carrier #2 is calculated by the following expression (4):

[Formula 4]

P_{diff}=M_{#1}(t)−M′_{#2}(t) Expression (4)

Subsequently, the transmission power difference determination unit 25 determines whether or not the estimated curve difference “P_{diff}” calculated by the expression (1) to the expression (4) exceeds the estimated curve difference threshold (Pₜₕᵣₑₛₕ) for a predetermined period.

It is needless to say that an estimated curve difference “P_{diff}” may simply be a difference between a value calculated by the estimated curve expression “M_{#1}(t)” and a value calculated by the estimated curve expression “M_{#2}(t)”, not a difference between a value calculated by the estimated curve expression “M_{#1}(t)” and a value calculated by the lower estimated curve expression “M′_{#2}(t)”.

Note that the transmission power difference determination unit 25 may determine whether or not the estimated curve difference “P_{diff}” exceeds the estimated curve difference threshold (Pₜₕᵣₑₛₕ) during the notch period.

When informed that an estimated curve difference between adjacent carriers has exceeded an estimated curve threshold for a predetermined period and that a transmission power difference between the adjacent carriers has exceeded a threshold set on the basis of a maximum transmission power difference, the communication controller 23 transmits a handoff request for requesting handoff of any one of the adjacent carriers.

### (Operation of Radio Communication Terminal)

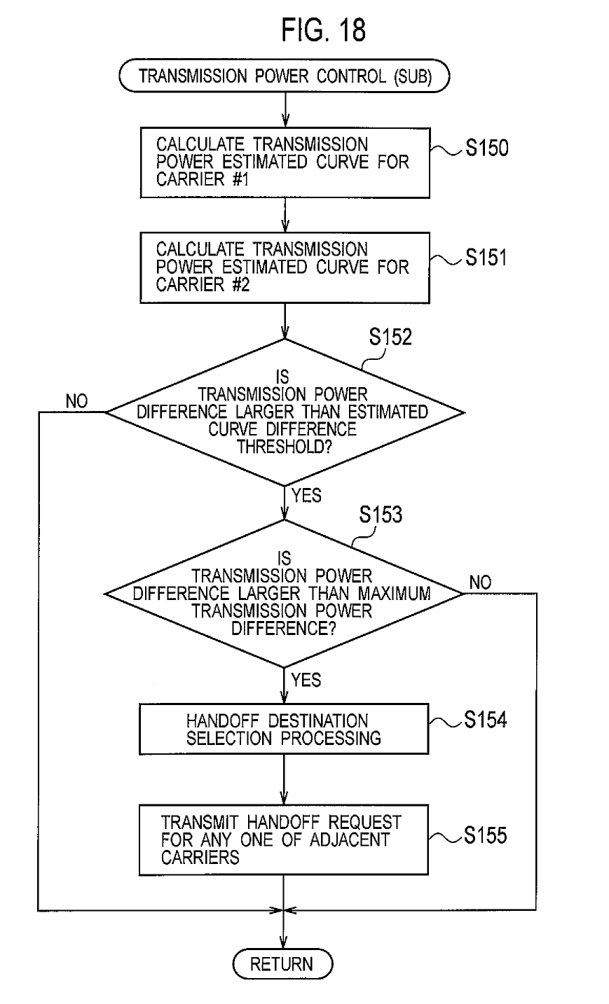

The operation of the radio communication terminal according to the fourth embodiment of the present invention will be described hereinafter with reference to the drawings. FIG. 18 is a flowchart of the operation of the radio communication terminal 10 according to the second embodiment of the present invention. Note that a sub-processing of controlling transmission power shown in FIG. 18 is performed instead of the aforementioned sub-processing of controlling transmission power shown in FIGS. 14 and 15.

Hereinafter, as in the case of the third embodiment, the case where adjacent carriers are a carrier #1 and a carrier #2 will be described as an example. In addition, the radio communication terminal 10 transmits reverse link data to the radio base station 100a by using the carrier #1 and transmits reverse link data to the radio base station 100b by using the carrier #2. Furthermore, the transmission power of the carrier #1 is larger than that of the carrier #2.

As shown in FIG. 18, in step 150, the radio communication terminal 10 calculates an estimated curve expression of the carrier #1 on the basis of the transmission power of reverse link data transmitted via the carrier #1 with higher transmission power.

In step 151, the radio communication terminal 10 calculates an estimated curve expression (or a lower estimated curve expression) of the carrier #2 on the basis of the transmission power of reverse link data transmitted via the carrier #2 with lower transmission power.

In step 152, based on the estimated curve expression of the carrier #1 calculated in step 150 and the estimated curve expression (or the lower estimated curve expression) of the carrier #2 calculated in step 151, the radio communication terminal 10 determines whether or not a transmission power difference between the carrier #1 and the carrier #2 has exceeded a estimated curve difference threshold. Specifically, the radio communication terminal 10 calculates a difference (estimated curve difference) between a value calculated by the estimated curve expression of the carrier #1 and a value calculated by the estimated curve expression (or the lower estimated curve expression) of the carrier #2. Subsequently, the radio communication terminal 10 determines whether or not the estimated curve difference exceeds an estimated curve difference threshold for a predetermined period.

When determining in step 152 that the estimated curve difference exceeds the estimated curve difference threshold for the predetermined period, the radio communication terminal 10 proceeds to the processing of step 153. On the other hand, when determining in step 152 that the estimated curve difference does not exceed the estimated curve difference threshold for the predetermined period, the radio communication terminal 10 terminates the sub-processing controlling the transmission power.

In step 153, the radio communication terminal 10 determines whether or not the transmission power difference between the carrier #1 and the carrier #2 exceeds the threshold set on the basis of the maximum transmission power difference. When determining in step 153 that the transmission power difference exceeds the threshold set on the basis of the maximum transmission power difference, the radio communication terminal 10 proceeds to the processing of step 154. When determining in step 153 that the transmission power difference does not exceed the threshold set on the basis of the maximum transmission power difference, the radio communication terminal 10 terminates the sub-processing of controlling transmission power.

In step 154, the radio communication terminal 10 selects a radio base station 100 to be the handoff destination from the radio base stations 100 located around the radio communication terminal 10, and selects a carrier to be used for transmitting reverse link data (handoff destination selection processing). Note that the handoff destination selection processing is the same processing as the aforementioned processing shown in FIG. 16.

In step 155, the radio communication terminal 10 transmits a handoff request for requesting handoff of a handoff target carrier of the adjacent carriers to the radio base station 100 to which the carrier (handoff target carrier) is connected. The handoff request herein includes information indicating the radio base station 100 and the carrier that are selected in step 154.

Note that the radio base station 100 having received the handoff request instructs the radio base station 100 indicated by the information included in the handoff request to connect to the radio communication terminal 10 via the carrier indicated by the information included in the handoff request.

### (Action and Effect)

With the radio communication terminal 10 according to the fourth embodiment of the present invention, the communication controller 23 transmits a handoff request for requesting handoff of one of adjacent carriers, not simply in the case where a transmission power difference between the adjacent carriers exceeds a threshold set on the basis of a maximum transmission power difference. The communication controller 23 transmits a handoff request for requesting handoff of one of adjacent carriers in the case where the transmission power difference between the adjacent carriers exceeds an estimated curve difference threshold for a predetermined period, and also the transmission power difference between the adjacent carriers exceeds the threshold set on the basis of the maximum transmission power difference.

Now, considered is a case where transmission power of the carrier temporarily increases through the open loop control or the closed loop control, as a result of deterioration of reception quality due to effect of fading or the like, for example. In such a case, even if the transmission power difference between the adjacent carriers temporarily exceeds a maximum transmission power difference set on the basis of a maximum transmission power difference, the transmission power difference between the adjacent carriers is likely to fall within the maximum transmission power difference when the effect of fading or the like is eliminated.

In the fourth embodiment of the present invention, unnecessary transmission of a handoff request can be prevented in the aforementioned case where the transmission power difference between adjacent carriers temporarily exceeds a threshold set on the basis of a maximum transmission power difference.

### Other Embodiments

As described above, content of the present invention was disclosed through an embodiment of the present invention. However, it should not be construed that the description and drawings constituting a part of this disclosure will limit the present invention. Various alternative embodiments will be apparent to those skilled in the art from this disclosure.

For example, in the aforementioned first and second embodiments, a handoff instruction for any one of adjacent carriers is transmitted on the basis of the determination as to whether or not a transmission power difference between the adjacent carriers exceeds a threshold set on the basis of a maximum transmission power difference. However, the present invention is not limited to this.

Specifically, a handoff instruction for any one of two carriers may be transmitted on the basis of the determination as to whether or not a transmission power difference between the two carriers that are not adjacent to each other exceeds a threshold set on the basis of a maximum transmission power difference.

In this case, a predetermined threshold is defined in accordance with the distance between the center frequencies of the two carriers being apart from each other. Specifically, as the center frequencies of the two carriers are apart from each other farther, the two carriers interfere with each other to a lower extent. Thus, the predetermined threshold is defined at a low value.

Furthermore, in the aforementioned third to fourth embodiments, the radio communication terminal 10 requests handoff of any one of adjacent carriers on the basis of the determination as to whether or not a transmission power difference between the adjacent carriers exceeds a threshold set on the basis of a maximum transmission power difference. However, the present invention is not limited to this.

Specifically, the radio communication terminal 10 may request handoff of any one of two carriers on the basis of the determination as to whether or not a transmission power difference between the two carriers that are not adjacent to each other exceeds a threshold set on the basis of a maximum transmission power difference.

In this case, a predetermined threshold is defined in accordance with the distance between the center frequencies of the two carriers being apart from each other. Specifically, as the center frequencies of the two carriers are apart from each other farther, the two carriers interfere with each other to a lower extent. Thus, the predetermined threshold is defined at a low value.

In addition, in the handoff destination selection processing shown in the third to fourth embodiments, the radio communication terminal 10 selects a carrier to be used for transmitting reverse link data, after selecting a radio base station 100 to be the handoff destination. However, the present invention is not limited to this.

Specifically, the radio communication terminal 10 may select a radio base station 100 to be the handoff destination after selecting a carrier to be used for transmitting reverse link data.

In general, transmission power of a reverse link carrier herein is controlled on the basis of reception quality of data received by the radio communication terminal, the data being transmitted from the radio base station to which the reverse link carrier is connected. Specifically, if the reception quality of data from the radio base station is high, the transmission power of the reverse link carrier is controlled to be lower. If the reception quality of data from the radio base station is low, the transmission power of the reverse link carrier is controlled to be higher. Accordingly, in general, as to a radio base station transmitting data with a small reception quality difference in a radio communication terminal, a transmission power difference between reverse link carriers connecting to the radio base station is also small.

Here, when selecting a radio base station 100 to be the handoff destination after selecting a carrier to be used for transmitting reverse link data, the radio communication terminal 10 selects a radio base station 100 to be the handoff destination with the following procedure.

(1) Calculates a difference between reception quality of data transmitted from a currently connected radio base station and reception quality of data transmitted from a handoff destination candidate base station.
(2) Select a radio base station transmitting data with a small reception quality difference (radio base station transmitting data with a small transmission power difference with respect to the reverse link carrier connecting to the currently connected radio base station) as the radio base station of the handoff destination.

A tolerance for the difference between the aforementioned reception qualities may be determined in accordance with the distance between the center frequencies of a carrier selected as the carrier to be used for transmitting reverse link data and a non-handoff target carrier. Specifically, as the center frequencies of the two carriers are apart from each other farther, the two carriers interfere with each other to a lower extent, so that the tolerance for the difference between the reception qualities may be relatively large (tolerance for a difference in transmission power of reverse link carriers). On the other hand, as the center frequencies of the two carriers are closer to each other, the two carriers interfere with each other to a higher extent, so that the tolerance for the difference between the reception qualities may be preferably set as small as possible (tolerance for a difference in transmission power of reverse link carriers).

In addition, the operation of the base station controller 200 according to the aforementioned first and second embodiments as well as the operation of the radio communication terminal 10 according to aforementioned the third to fourth embodiments can be provided as an executable program in a computer.

In this way, it is needless to say that the present invention contains various embodiments that have not been described herein. Thus, a technical scope of the present invention shall be defined only by inventive specific matters according to the claims that are reasonable from the above description.

Note that the entire contents of Japanese Patent Applications No. 2006-207239 (filed on Jul. 28, 2006) and No. 2006-207253 (filed on Jul. 28, 2006) are incorporated herein by reference in this description.

### INDUSTRIAL APPLICABILITY

As described above, the radio communication method, the base station controller and the radio communication terminal according to the present invention can maintain communications by multicarrier while controlling interference between adjacent carries that are adjacent to each other with a predetermined frequency interval. Accordingly, they are useful in radio communications such as mobile communications.

1. A radio communication method in reverse link from a radio communication terminal to a radio base station by multicarrier using at least a first carrier and a second carrier that is adjacent to the first carrier with a predetermined frequency interval, the method comprising the steps of:
acquiring a transmission power value of the first carrier and a transmission power value of the second carrier from the radio base station;
calculating a transmission power difference between the first carrier and the second carrier;
determining whether or not the transmission power difference exceeds a threshold set on the basis of a maximum transmission power difference allowable between the first carrier and the second carrier; and
when the transmission power difference exceeds the threshold set on the basis of the maximum transmission power difference, transmitting a handoff instruction for one of the first carrier and the second carrier that has a higher transmission power value, to the radio base station connected to the radio communication terminal via the one of the carriers that has the higher transmission power value.

2. The radio communication method according to claim 1, wherein the transmission power difference is calculated in a predetermined cycle in the step of calculating the transmission power difference,
the radio communication method further comprising the step of determining whether or not the transmission power difference is increasing, on the basis of the transmission power difference calculated in the predetermined cycle, wherein
when it is determined that the transmission power difference is increasing, a handoff instruction for the one of the first carrier and the second carrier that has the higher transmission power value is transmitted to the radio base station connected to the radio communication terminal via the one of the carriers that has the higher transmission power value in the step of transmitting the handoff instruction.

3. A radio communication method in reverse link from a radio communication terminal to a radio base station by multicarrier using at least a first carrier and a second carrier that is adjacent to the first carrier with a predetermined frequency interval, the method comprising the steps of:
acquiring a transmission power value of the first carrier and a transmission power value of the second carrier from the radio base station;
calculating a transmission power difference between the first carrier and the second carrier;
determining whether or not the transmission power difference exceeds a threshold set on the basis of a maximum transmission power difference allowable between the first carrier and the second carrier; and
when the transmission power difference exceeds the threshold set on the basis of the maximum transmission power difference, transmitting a handoff instruction for one of the first carrier and the second carrier that has a lower transmission power value, to the radio base station connected to the radio communication terminal via the one of the carriers that has the lower transmission power value.

4. The radio communication method according to claim 3, wherein the transmission power difference is calculated in a predetermined cycle in the step of calculating the transmission power difference,
the radio communication method further comprising the step of determining whether or not the transmission power difference is increasing, on the basis of the transmission power difference calculated in the predetermined cycle, wherein
when it is determined that the transmission power difference is increasing, a handoff instruction for the one of the first carrier and the second carrier that has the lower transmission power value is transmitted to the radio base station connected to the radio communication terminal via the one of the carriers that has the lower transmission power value in the step of transmitting the handoff instruction.

5. A base station controller for controlling communications in reverse link from a radio communication terminal to a radio base station by multicarrier using at least a first carrier and a second carrier that is adjacent to the first carrier with a predetermined frequency interval, the controller comprising:
a transmission power value acquisition unit configured to acquire a transmission power value of the first carrier and a transmission power value of the second carrier from the radio base station;
a transmission power difference calculator configured to calculate a transmission power difference between the first carrier and the second carrier on the basis of the transmission power value of the first carrier and the transmission power value of the second carrier, which are acquired by the transmission power value acquisition unit;
a transmission power difference determination unit configured to determine whether or not the transmission power difference calculated by the transmission power difference calculator exceeds a threshold set on the basis of a maximum transmission power difference allowable between the first carrier and the second carrier; and
a handoff instruction transmitter configured to transmit a handoff instruction for one of the first carrier and the second carrier that has a higher transmission power value to the radio base station connected to the radio communication terminal via the one of the carriers that has the higher transmission power value, when the transmission power difference determination unit determines that the transmission power difference exceeds the threshold set on the basis of the maximum transmission power difference.

6. The base station controller according to claim 5, wherein the transmission power difference calculator calculates the transmission power difference in a predetermined cycle,
the controller further comprising a power difference determination unit configured to determine whether or not the transmission power difference is increasing, on the basis of the transmission power difference calculated in the predetermined cycle by the transmission power difference calculator, wherein
when it is determined that the transmission power difference is increasing, the handoff instruction transmitter transmits a handoff instruction for the one of the first carrier and the second carrier that has the higher transmission power value, to the radio base station connected to the radio communication terminal via the one of the carriers that has the higher transmission power value.

7. A base station controller for controlling communications in reverse link from a radio communication terminal to a radio base station by multicarrier using at least a first carrier and a second carrier that is adjacent to the first carrier with a predetermined frequency interval, the controller comprising:
a transmission power value acquisition unit configured to acquire a transmission power value of the first carrier and a transmission power value of the second carrier from the radio base station;
a transmission power difference calculator configured to calculate a transmission power difference between the first carrier and the second carrier on the basis of the transmission power value of the first carrier and the transmission power value of the second carrier, which are acquired by the transmission power value acquisition unit;
a transmission power difference determination unit configured to determine whether or not the transmission power difference calculated by the transmission power difference calculator exceeds a threshold set on the basis of a maximum transmission power difference allowable between the first carrier and the second carrier; and
a handoff instruction transmitter configured to transmit a handoff instruction for one of the first carrier and the second carrier that has a lower transmission power value to the radio base station connected to the radio communication terminal via the one of the carriers that has the lower transmission power value, when the transmission power difference determination unit determines that the transmission power difference exceeds the threshold set on the basis of the maximum transmission power difference.

8. The base station controller according to claim 7, wherein the transmission power difference calculator calculates the transmission power difference in a predetermined cycle,
the base station controller further comprising a power difference determination unit configured to determine whether or not the transmission power difference is increasing, on the basis of the transmission power difference calculated in the predetermined cycle by the transmission power difference calculator, wherein
when it is determined that the transmission power difference is increasing, the handoff instruction transmitter transmits a handoff instruction for the one of the first carrier and the second carrier that has the lower transmission power value to the radio base station connected to the radio communication terminal via the one of the carriers that has the lower transmission power value.

9. A radio communication method in reverse link by multicarrier using at least a first carrier and a second carrier that is adjacent to the first carrier with a predetermined frequency interval, the method comprising the steps of:
calculating a transmission power difference between the first carrier and the second carrier;
determining whether or not the transmission power difference exceeds a threshold set on the basis of a maximum transmission power difference allowable between the first carrier and the second carrier; and
when the transmission power difference exceeds the threshold set on the basis of the maximum transmission power difference, transmitting a handoff request for one of the first carrier and the second carrier that has higher transmission power to the radio base station connected to the radio communication terminal via the one of the carriers that has the higher transmission power.

10. The radio communication method according to claim 9, wherein the transmission power difference is calculated in a predetermined cycle in the step of calculating the transmission power difference,
the radio communication method further comprising the step of determining whether or not the transmission power difference is increasing, on the basis of the transmission power difference calculated in the predetermined cycle, wherein
when it is determined that the transmission power difference is increasing, a handoff request for the one of the first carrier and the second carrier that has the higher transmission power is transmitted to the radio base station connected to the radio communication terminal via the one of the carriers that has the higher transmission power, in the step of transmitting the handoff request.

11. A radio communication method in reverse link by multicarrier using at least a first carrier and a second carrier that is adjacent to the first carrier with a predetermined frequency interval, the method comprising the steps of:
calculating a transmission power difference between the first carrier and the second carrier;
determining whether or not the transmission power difference exceeds a threshold set on the basis of a maximum transmission power difference allowable between the first carrier and the second carrier; and
when the transmission power difference exceeds the threshold set on the basis of the maximum transmission power difference, transmitting a handoff request for one of the first carrier and the second carrier that has lower transmission power to the radio base station connected to the radio communication terminal via the one of the carriers that has the lower transmission power.

12. The radio communication method according to claim 11, wherein the transmission power difference is calculated in a predetermined cycle in the step of calculating the transmission power difference,
the radio communication method further comprising the step of determining whether or not the transmission power difference is increasing, on the basis of the transmission power difference calculated in the predetermined cycle, wherein
when it is determined that the transmission power difference is increasing, a handoff request for the one of the first carrier and the second carrier that has the lower transmission power is transmitted to the radio base station connected to the radio communication terminal via the one of the carriers that has the lower transmission power, in the step of transmitting the handoff request.

13. A radio communication terminal for performing communications by multicarrier using at least a first carrier and a second carrier that is adjacent to the first carrier with a predetermined frequency interval, the communication terminal comprising:
a transmission power difference calculator configured to calculate a transmission power difference between the first carrier and the second carrier;
a transmission power difference determination unit configured to determine whether or not the transmission power difference calculated by the transmission power difference calculator exceeds a threshold set on the basis of a maximum transmission power difference allowable between the first carrier and the second carrier; and
a handoff request transmitter configured to transmit a handoff request for one of the first carrier and the second carrier that has higher transmission power to the radio base station connected to the radio communication terminal via the one of the carriers that has the higher transmission power, when the transmission power difference determination unit determines that the transmission power difference exceeds the threshold set on the basis of the maximum transmission power difference.

14. The radio communication terminal according to claim 13, wherein the transmission power difference calculator calculates the transmission power difference in a predetermined cycle,
the communication terminal further comprising a power difference determination unit configured to determine whether or not the transmission power difference is increasing, on the basis of the transmission power difference calculated in the predetermined cycle by the transmission power difference calculator, wherein
when it is determined that the transmission power difference is increasing, the handoff request transmitter transmits a handoff request for the one of the first carrier and the second carrier that has the higher transmission power to the radio base station connected to the radio communication terminal via the one of the carriers that has the higher transmission power.

15. A radio communication terminal for performing communications by multicarrier using at least a first carrier and a second carrier that is adjacent to the first carrier with a predetermined frequency interval, the communication terminal comprising:
a transmission power difference calculator configured to calculate a transmission power difference between the first carrier and the second carrier;
a transmission power difference determination unit configured to determine whether or not the transmission power difference calculated by the transmission power difference calculator exceeds a threshold set on the basis of a maximum transmission power difference allowable between the first carrier and the second carrier; and
a handoff request transmitter configured to transmit a handoff request for one of the first carrier and the second carrier that has lower transmission power to the radio base station connected to the radio communication terminal via the one of the carriers that has the lower transmission power, when the transmission power difference determination unit determines that the transmission power difference exceeds the threshold set on the basis of the maximum transmission power difference.

16. The radio communication terminal according to claim 15, wherein the transmission power difference calculator calculates the transmission power difference in a predetermined cycle,
the radio communication terminal further comprising a power difference determination unit configured to determine whether or not the transmission power difference is increasing, on the basis of the transmission power difference calculated in the predetermined cycle by the transmission power difference calculator, wherein
when it is determined that the transmission power difference is increasing, the handoff request transmitter transmits a handoff request for the one of the first carrier and the second carrier that has the lower transmission power to the radio base station connected to the radio communication terminal via the one of the carriers that has the lower transmission power.
